(19) United States
(12) Patent Application Publication
(10) Pub. No.: US 2024/0329410 A1
(43) Pub. Date: Oct. 3, 2024

(54) OPTICAL DEVICE AND HEAD-MOUNTED DISPLAY

(71) Applicant: FUJIFILM Corporation, Tokyo (JP)

(72) Inventor: Eiichiro AMINAKA, Kanagawa (JP)

(73) Assignee: FUJIFILM Corporation, Tokyo (JP)

(21) Appl. No.: 18/742,714

(22) Filed: Jun. 13, 2024

Related U.S. Application Data
(63) Continuation of application No. PCT/JP2022/045351, filed on Dec. 8, 2022.

(30) Foreign Application Priority Data
Dec. 17, 2021 (JP) 2021-205064
Jul. 21, 2022 (JP) 2022-116454

(51) Int. Cl. G02B 27/01; G02B 5/00; G02B 5/30; G06T 19/00

(52) U.S. Cl. CPC G02B 27/0172; G02B 5/003; G02B 5/3083; G02B 6/0026; G06T 19/006

(57) ABSTRACT

An optical device in which, for use in a head-mounted display, visibility of the background is excellent and rainbow unevenness caused by external light incident from the upper front side of the head of a user can be suppressed; and a head-mounted display. The optical device includes: a light guide plate having a surface on which a diffraction element is disposed; and an optical filter that includes an anisotropic light absorbing layer, in which an angle between an absorption axis of the anisotropic light absorbing layer and a normal direction of a main surface of the anisotropic light absorbing layer is 0° to 45°.

### CROSS-REFERENCE TO RELATED APPLICATIONS

This application is a Continuation of PCT International Application No. PCT/JP2022/045351 filed on Dec. 8, 2022, which was published under PCT Article 21 (2) in Japanese, and which claims priority under 35 U.S.C. § 119 (a) to Japanese Patent Application No. 2021-205064 filed on Dec. 17, 2021 and Japanese Patent Application No. 2022-116454 filed on Jul. 21, 2022. The above applications are hereby expressly incorporated by reference, in their entirety, into the present application.

### BACKGROUND OF THE INVENTION

### 1. Field of the Invention

The present invention an optical device including an optical filter and a head-mounted display.

### 2. Description of the Related Art

In recent years, a head-mounted display such as augmented reality (AR) glasses that project a video to superimpose the video on the background have appeared.

The AR glasses are configured to include, for example, an image display element, a light guide plate, and a diffraction element, in which video light emitted from the image display element is diffracted by the diffraction element, is incident into the light guide plate, and is guided by the light guide plate such that the guided video light is diffracted by the diffraction element to display the video toward a viewer. Since the light guide plate is transparent, the AR glasses can project the video to superimpose the video on the background.

In the AR glasses, external light incident from a specific oblique direction is diffracted in the direction of the viewer by the diffraction element. Therefore, there is a problem in that rainbow unevenness in which external light is recognized by the viewer in an iridescently reflected glare state on the background is recognized. The specific oblique direction refers to a direction perpendicular (substantially perpendicular) to a slit direction of the diffraction element.

An incidence angle (incidence angle oblique to a main surface of the diffraction element) at which external light is recognized changes depending on a pitch of the diffraction element. However, there is particularly a problem in that external light incident at 40° to 80° with respect to the normal line of the diffraction element is recognized as the rainbow unevenness.

For example, in the diffraction element where the slit direction is close to the horizontal direction in the usage state of the AR glasses or the like, external light incident from the upper front side of the head is recognized as reflected glare rainbow unevenness.

On the other hand, in some AR glasses, by reducing a transmittance of external light using a so-called neutral density filter (ND filter), recognition of rainbow unevenness caused by incidence of external light is suppressed.

### SUMMARY OF THE INVENTION

However, in a head-mounted display where the background of AR glasses or the like is visible, in a case where the ND filter is used, the transmittance of the ND filter needs to be reduced to sufficiently suppress the recognition of the rainbow unevenness. Therefore, in the AR glasses or the like where the ND filter is used, not only the transmittance of light incident from the upper side but also the transmittance incident from the front direction, that is, the background decrease.

As a result, in the AR glasses or the like where the ND filter is used, the recognition of rainbow unevenness caused by incidence of external light can be suppressed, but the visibility of the background in the front direction deteriorates.

An object of the present invention is to solve the above-described problem and to provide: an optical device in which, for use in a head-mounted display such as AR glasses where the background is visible, visibility of the background in the front direction is excellent and further recognition of rainbow unevenness caused by external light incident from the upper front side of the head of a user who uses the head-mounted display can also be suppressed; and a head-mounted display including the optical device.

The present inventors have found that the above-described objects can be achieved by the following configurations.

[1] An optical device comprising:
a light guide plate having a surface on which a diffraction element is disposed; and
an optical filter that includes an anisotropic light absorbing layer,
in which an angle between an absorption axis of the anisotropic light absorbing layer and a normal direction of a main surface of the anisotropic light absorbing layer is 0° to 45°.

[2] The optical device according to [1],
in which the optical filter further includes a polarizer having an absorption axis in a main surface.

[3] The optical device according to [2],
wherein an angle between a slit direction of a diffraction element where the slit direction is closest to a horizontal direction among the diffraction elements and an absorption axis of the polarizer is 0° to 45°.

[4] The optical device according to any one of [1] to [3],
in which two or more diffraction elements are disposed on the light guide plate, and
the optical filter is provided to cover at least a diffraction element where an angle between a slit direction and a horizontal direction is smallest among the diffraction elements.

[5] The optical device according to any one of [2] to [4],
in which the optical filter includes a retardation layer between the anisotropic light absorbing layer and the polarizer.

[6] The optical device according to [5],
in which the retardation layer is a B-plate having an Nz coefficient of 1.5 or more.

[7] The optical device according to [5],
in which the retardation layer includes at least a positive A-plate and a positive C-plate, and
the positive A-plate is provided on an anisotropic light absorbing layer side.

[8] The optical device according to any one of [1] to [7],
in which on a surface of the light guide plate, an incidence diffraction element for allowing light to be incident into the light guide plate, an intermediate diffraction element that deflects a light guide direction of light diffracted by the incidence diffraction element, and an emission diffraction element that emits light diffracted by the intermediate diffraction element from the light guide plate are disposed.

[9] The optical device according to [8],
in which a slit direction of the intermediate diffraction element and a slit direction of the emission diffraction element are different from each other,
the optical filter is provided in a region covering the intermediate diffraction element and in a region covering the emission diffraction element,
a direction of an absorption axis of the polarizer of the optical filter varies between the region covering the intermediate diffraction element and the region covering the emission diffraction element,
an angle between the absorption axis of the polarizer of the optical filter and the slit direction of the intermediate diffraction element is 0° to 45°, and
an angle between the absorption axis of the polarizer of the optical filter and the slit direction of the emission diffraction element is 0° to 45°.

[10] The optical device according to any one of [1], [4], and [8],
in which the optical filter includes at least a first anisotropic light absorbing layer, one or more retardation layers having a twisted structure, and a second anisotropic light absorbing layer.

[11] The optical device according to any one of [1] to [10],
in which the optical filter is disposed on an opposite observation surface side of the light guide plate.

[12] The optical device according to any one of [1] to [11],
in which the optical filter is disposed on both surfaces of the light guide plate.

[13] The optical device according to any one of [5] to [7],
in which wavelength dependence of the retardation layer of the optical filter satisfies Re(450 nm)<Re(550 nm)<Re(650 nm) or Rth(450 nm)<Rth(550 nm)<Rth(650 nm).

[14] A head-mounted display comprising:
the optical device according to any one of [1] to [13]; and
an image display element.

According to the present invention, in a head-mounted display such as AR glasses where the background is visible, visibility of the background in the front direction is excellent, and further recognition of rainbow unevenness caused by external light incident from the upper front side of the head of a user can also be suppressed.

### BRIEF DESCRIPTION OF THE DRAWINGS

FIG. 1 is a schematic diagram showing an example of a head-mounted display according to the present invention.

FIG. 2 is a schematic diagram showing an example of a head-mounted display in the related art.

FIG. 3 is a schematic diagram showing an example of a configuration of a light guide plate for AR glasses.

FIG. 4 is a conceptual diagram showing the light guide plate shown in FIG. 3.

FIG. 5 is a conceptual diagram showing a slit direction of a liquid crystal diffraction element.

FIG. 6 is a schematic diagram showing a plan view of an evaluation system of a head-mounted display according to the present invention.

FIG. 7 is a schematic diagram showing an elevational view of the evaluation system of the head-mounted display according to the present invention.

### DESCRIPTION OF THE PREFERRED EMBODIMENTS

Hereinafter, the present invention will be specifically described. In the present specification, numerical ranges represented by “to” include numerical values before and after “to” as lower limit values and upper limit values.

In the present specification, Re(λ) and Rth(λ) represent an in-plane retardation (nm) and a thickness-direction retardation (nm) at a wavelength λ, respectively. Re(λ) is measured by causing light having the wavelength λ nm to be incident in a film normal direction in AxoScan (manufactured by Axometrics Inc.).

In a case where the film to be measured is represented by an uniaxial or biaxial index ellipsoid, Rth(λ) is calculated using the following method. In a case where the measurement wavelength λ nm is selected, the measurement can be performed by manually replacing a wavelength selective filter or by converting a measured value with a program or the like.

Rth(λ) is obtained using a method including: measuring Re(λ) at seven points in total in a case where an in-plane slow axis is used as a tilt axis (rotation axis) and light having the wavelength λ nm is incident from a direction tilted from the normal direction to 60 degrees on one side with respect to the film normal direction at steps of 10 degrees; and calculating Rth(λ) using AxoScan based on the measured retardation values, an assumed value of an average refractive index, and an input film thickness value. In this case, the film in-plane slow axis is determined by AxoScan. In addition, in a case where a slow axis is not present in a plane of the film, any direction in the plane of the film is set as the rotation axis.

In the case of a film having a direction in which a retardation value is zero at one tilt angle from the normal direction with respect to the in-plane slow axis as a rotation axis, a retardation value at a tilt angle more than the tilt angle is calculated by AxoScan after changing the sign into minus.

Retardation values were measured from any two directions tilted with respect to a slow axis as a tilt axis (rotation axis), and Rth can also be calculated from Expression (I) and Expression (II) based on the measured retardation values, an assumed value of an average refractive index, and an input film thickness value. Even in this case, in a case where a slow axis is not present in a plane of the film, any direction in the plane of the film is set as the rotation axis.

$$Re ( θ ) = [ \text{} nx - \frac{ny \times nz}{\sqrt{{( ny sin ( {sin}^{- 1} ( \frac{sin ( - θ )}{nx} ) ) )}^{2} + {( nz cos ( {sin}^{- 1} ( \frac{sin ( - θ )}{nx} ) ) )}^{2}}} ] \times \frac{d}{cos ( {sin}^{- 1} ( \frac{sin ( - θ )}{nx} ) )} \qquad Expression ( I )$$

$$Rth = ( ( nx + ny ) / 2 - nz ) \times d \qquad Expression ( II )$$

In the expressions, Re(θ) represents a retardation value in a direction tilted at an angle θ from the normal direction.

In addition, nx represents a refractive index in a slow axis direction in a plane, ny represents a refractive index in a direction orthogonal to nx in the plane, nz represents a refractive index in a direction orthogonal to nx and ny, and d represents a film thickness.

In a case where the film to be measured is a film that cannot be represented by an uniaxial or biaxial index ellipsoid and does not have a so-called optic axis, Rth(λ) is calculated using the following method.

Rth(λ) is obtained using a method including: measuring Re(λ) at 13 points in a case where an in-plane slow axis is used as a tilt axis (rotation axis) and light having the wavelength nm is incident from a direction tilted from −60 degrees to 60 degrees with respect to the film normal direction at steps of 10 degrees; and calculating Rth(λ) using AxoScan based on the measured retardation values, an assumed value of an average refractive index, and an input film thickness value. In this case, the film in-plane slow axis is determined by AxoScan.

In addition, in the above-described measurement, as the assumed value of the average refractive index, values described in “Polymer Handbook” (John Wiley&Sons, Inc.) and catalogs of various optical compensation films can be used.

In addition, regarding films of which average refractive index values are not known, the average refractive index values are measured using an Abbe refractometer. Examples of average refractive index values of main optical compensation films are as follows:
cellulose acylate (1.48), a cycloolefin polymer (1.52), polycarbonate (1.59), polymethyl methacrylate (1.49), and polystyrene (1.59).

By inputting the assumed value of the average refractive index and the film thickness, AxoScan calculates nx, ny, and nz. Based on the calculated nx, ny, and nz, Nz=(nx−nz)/(nx−ny) is further calculated.

Unless otherwise specified, Re, Rth, and the measurement wavelength of the refractive index are values at λ=550 nm in a visible range.

In addition, in the present specification, “main axis” represents a main refractive index axis of an index ellipsoid calculated by AxoScan. Regarding, nx, ny, and nz, unless otherwise specified, “main axis” represents a main refractive index nz in a film thickness direction.

### Head-Mounted Display

A head-mounted display according to an embodiment of the present invention comprises:
an optical device according to an embodiment of the present invention; and
an image display element.

The optical device according to the embodiment of the present invention comprises: a light guide plate that is disposed on a surface (main surface) of a diffraction element; and an optical filter that includes an anisotropic light absorbing layer. In the optical filter of the optical device according to the embodiment of the present invention, an angle between an absorption axis of the anisotropic light absorbing layer and a normal line of a main surface of the anisotropic light absorbing layer is 0° to 45°. In addition, it is preferable that, in the optical device according to the embodiment of the present invention, the optical filter further includes a polarizer having an absorption axis in a main surface.

The main surface is each of the maximum surfaces of a sheet-shaped material (a layer, a plate-shaped material, or a film), and is typically both surfaces of the sheet-shaped material in the thickness direction.

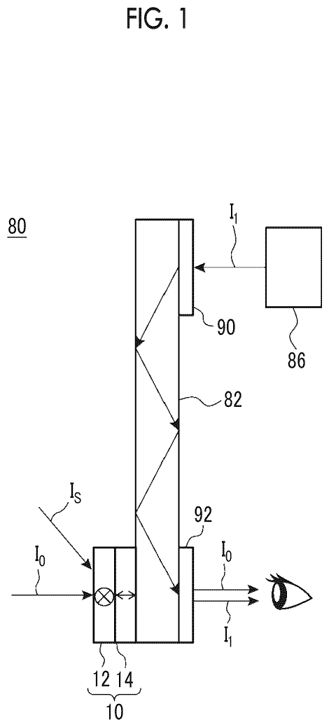

FIG. 1 is a schematic diagram showing an example of the head-mounted display according to the embodiment of the present invention.

A head-mounted display 80 shown in FIG. 1 is, for example, AR glasses and includes a light guide plate 82, an incidence diffraction element 90 and an emission diffraction element 92 that are disposed on one surface of the light guide plate 82, an optical filter 10, and an image display element 86. The light guide plate 82, the incidence diffraction element 90, the emission diffraction element 92, and the optical filter 10 configure the optical device according to the embodiment of the present invention.

As shown in FIG. 1, the incidence diffraction element 90 is disposed on a surface (main surface) of the light guide plate 82 on one end part side. In addition, the emission diffraction element 92 is disposed on the surface of the light guide plate 82 on another end part side.

A disposition position of the incidence diffraction element 90 corresponds to an incidence position of video light Ii from the image display element 86 into the light guide plate 82. On the other hand, an disposition position of the emission diffraction element 92 corresponds to an emission position of the video light I₁ from the light guide plate 82, that is, an observation position of the video light I₁ by a user. In addition, the incidence diffraction element 90 and the emission diffraction element 92 are disposed on the same surface of the light guide plate 82.

In addition, the optical filter 10 faces the emission diffraction element 92 of the light guide plate 82, and is disposed on a surface of the light guide plate 82 opposite to the surface where the emission diffraction element 92 is disposed. As shown in FIG. 1, the optical filter 10 has the same planar shape as the emission diffraction element 92.

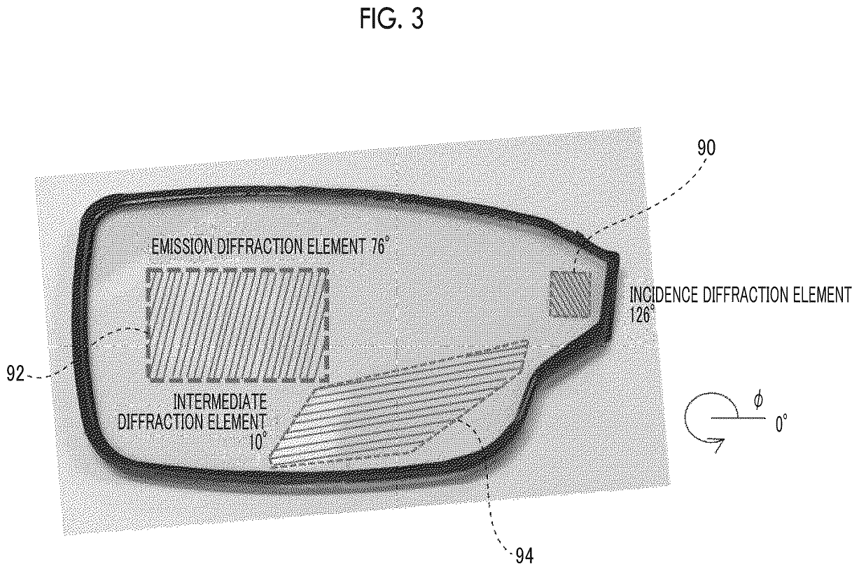

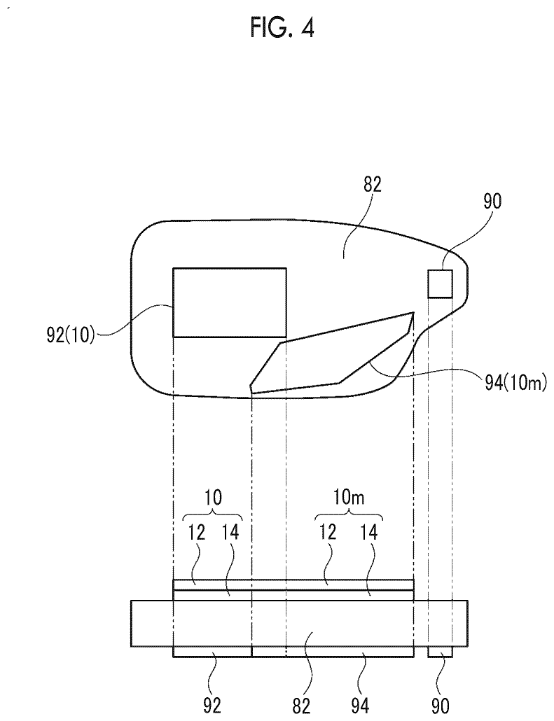

In the light guide plate 82, an intermediate diffraction element may be provided (refer to FIGS. 3 and 4).

In addition, the disposition position of each of the diffraction elements is not limited to the end part of the light guide plate, and various positions can be used depending on the shape of the light guide plate and the like.

In the head-mounted display 80 (AR glasses) having the above-described configuration, as indicated by an arrow, the video light I₁ displayed by the image display element 86 is diffracted by the incidence diffraction element 90 to be incident into the light guide plate 82 at an angle at which the light is totally reflected from an interface between the light guide plate 82 and air.

The video light I₁ incident into the light guide plate 82 is totally reflected from both of the surfaces of the light guide plate 82, is guided in the light guide plate 82, and is incident into the emission diffraction element 92.

The video light I₁ incident into the emission diffraction element 92 is diffracted by the emission diffraction element 92 in a direction perpendicular to the surface of the emission diffraction element 92.

The video light I₁ diffracted by the emission diffraction element 92 is emitted to the observation position by a user outside the light guide plate 82, and is observed by the user.

In addition, as shown in FIG. 1, external light I₀ incident from the front direction into the head-mounted display 80, that is, the background transmits through the optical filter 10, is incident into the light guide plate 82, transmits through the emission diffraction element 92, and reaches the observation position by the user. In the following description, the external light incident from the front direction into the head-mounted display 80 will also be referred to as the front external light I₀.

As a result, in the head-mounted display 80, a video displayed by the image display element 86 is incident into one end of the light guide plate 82, propagates in the light guide plate 82, and is emitted from another end of the light guide plate 82 such that the virtual video is displayed to be superimposed on a scene that is actually being seen by the user.

Here, the head-mounted display 80 includes the light guide plate 82, the incidence diffraction element 90, the emission diffraction element 92, the image display element 86, and the optical filter 10.

In the head-mounted display 80 in the example shown in the drawing, the optical filter 10 is disposed on the surface (opposite observation surface) of the light guide plate 82 opposite to the emission diffraction element 92 to face the emission diffraction element 92. Accordingly, as described above, the user of the head-mounted display 80 observes not only the video light I₁ displayed by the image display element 86 but also the front external light I₀ (background) transmitted through the optical filter 10, the light guide plate 82, and the emission diffraction element 92.

The optical filter 10 will be described below in detail.

The light guide plate 82 is not particularly limited, and well-known light guide plates of the related art that are used for image display apparatuses, for example, light guide plates used for various AR glasses or light guide plates used for backlight units of liquid crystal display devices can be used.

The incidence diffraction element 90 diffracts light emitted from the image display element 86 at an angle at which the light is totally reflected in the light guide plate 82, and causes the diffracted light to be incident into the light guide plate 82. The emission diffraction element 92 diffracts the light guided in the light guide plate 82, and emits the diffracted light from the light guide plate 82.

The incidence diffraction element 90 and the emission diffraction element 92 are not particularly limited, and various well-known diffraction elements used in AR glasses, for example, a relief type diffraction element, a diffraction element using liquid crystal, or a volume hologram diffraction element can be used.

Here, in the example shown in FIG. 1, the incidence diffraction element 90 and the emission diffraction element 92 are transmissive diffraction elements. However, the present invention is not limited to this configuration, and the incidence diffraction element 90 and the emission diffraction element 92 may be reflective diffraction elements.

In a case where the incidence diffraction element 90 is a reflective diffraction element, the incidence diffraction element 90 is disposed on the surface (opposite observation surface) of the light guide plate 82 opposite to the surface (observation surface) facing the image display element 86. In addition, the emission diffraction element 92 is disposed on the surface of the light guide plate 82 opposite to the surface facing the user.

Even in this case, it is preferable that the optical filter 10 described below is disposed on the surface (opposite observation surface side) of the emission diffraction element 92 opposite to the user side.

Regarding the description of the diffraction element, the same can be applied to an intermediate diffraction element described below.

As shown in FIG. 1, the image display element 86 is disposed to face the incidence diffraction element 90. In addition, the surface side where the emission diffraction element 92 is disposed is the observation position of the user.

The image display element 86 is not particularly limited, and various well-known image display elements (displays) used for various image display apparatuses such as AR glasses can be used.

Examples of the image display element 86 include a liquid crystal display, an organic electroluminescent display, a digital light processing (DLP), a micro electro mechanical systems (MEMS) display, and a micro light emitting diode (LED) display. Examples of the liquid crystal display include a liquid crystal on silicon (LCOS).

The image display element 86 may display a monochrome image, a two-color image, or a color image.

As described above, the head-mounted display according to the embodiment of the present invention, that is, the optical device according to the embodiment of the present invention may include an intermediate diffraction element in addition to the incidence diffraction element 90 and the emission diffraction element 92.

FIG. 3 conceptually shows the optical device including the intermediate diffraction element. In addition, FIG. 4 schematically shows the optical device shown in FIG. 3.

As shown in FIGS. 3 and 4, the optical device includes an intermediate diffraction element 94 and an optical filter 10m in addition to the light guide plate 82, the incidence diffraction element 90, the emission diffraction element 92, and the optical filter 10 described above.

As in the example described above, all of the incidence diffraction element 90, the emission diffraction element 92, and the intermediate diffraction element 94 are disposed on one surface (main surface) of the light guide plate 82.

In addition, the optical filter 10 and the optical filter 10m are disposed on the other surface of the light guide plate 82.

The optical filter 10 has the same planar shape as the emission diffraction element 92, and is disposed to face the emission diffraction element 92 and to overlap the emission diffraction element 92 in a main surface direction of the light guide plate 82. The optical filter 10m has the same planar shape as the intermediate diffraction element 94, and is disposed to face the intermediate diffraction element 94 and to overlap the intermediate diffraction element 94 in the main surface direction of the light guide plate 82. The planar shape is a shape of the main surface of the diffraction element, the optical filter, and the like.

The planar shape of the optical filter is not limited to the same shape as the planar shape of the diffraction element, may have a different shape or a different size. However, in order to suitably shields external light incident into the diffraction element from an oblique direction, that is, oblique external light I_{S} and to suppress unnecessary light shielding of the background, that is, the front external light I₀, it is preferable that the diffraction element and the optical filter have the same planar shape including the size.

In other words, in the optical device according to the embodiment of the present invention, the optical filter may overlap at least a part of the corresponding diffraction element in a view from the normal direction of the light guide plate. However, the optical filter preferably covers the entire surface of the corresponding diffraction element and more preferably completely overlaps the corresponding diffraction element in a view from the normal direction of the light guide plate.

That is, in the present invention, “the optical filter covering the diffraction element” represents that the optical filter overlaps at least a part of the diffraction element in a view from the normal direction of the light guide plate. In the present invention, “the optical filter covering the diffraction element” will also be referred to as “the optical filter corresponding to the diffraction element”.

In addition, in the example shown in FIGS. 1, 3, and 4, the optical filters individually corresponding to the emission diffraction element 92 and the intermediate diffraction element 94 are provided, but the present invention is not limited to this configuration.

That is, in the optical device according to the embodiment of the present invention, one optical filter 10 that covers the entire area of one surface of the light guide plate 82 may be provided, or one optical filter that covers a plurality of diffraction elements such as the emission diffraction element 92 and the intermediate diffraction element 94 may be provided. In this case, a direction of an absorption axis of a polarizer 12 may be uniform over the entire surface of the optical filter. However, in a case where one optical filter covers a plurality of diffraction elements, it is preferable that an angle between the absorption axis of the polarizer 12 and a slit direction of each of the diffraction elements is adjusted in a region covering each of the diffraction elements as in Example 4 (optical filter 4) described below.

Even in a head-mounted display such as AR glasses including the optical device shown in FIGS. 3 and 4, an image display element is also provided such that video light is incident into the incidence diffraction element 90.

The video light displayed by the image display element is diffracted by the incidence diffraction element 90 and is incident into the light guide plate 82 at an angle at which the light is totally reflected from an interface between the light guide plate 82 and air.

The video light diffracted by the incidence diffraction element 90 and incident into the light guide plate 82 is totally reflected and guided in the light guide plate 82, and is incident into the intermediate diffraction element 94. The video light incident into the intermediate diffraction element 94 is diffracted by the intermediate diffraction element 94, is deflected in a light guide direction in the light guide plate 82, and is incident into the emission diffraction element 92. The video light incident into the emission diffraction element 92 is diffracted by the emission diffraction element 92, is emitted from the light guide plate 82 to the observation position by the user, and is observed by the user.

As described above, in the optical device according to the embodiment of the present invention, the optical filter 10 covering the emission diffraction element 92 is provided on the side of the light guide plate 82 opposite to the surface where the diffraction element is provided. In an aspect including the intermediate diffraction element 94, the optical filter 10m covering the intermediate diffraction element is further provided.

The optical element according to the embodiment of the present invention includes the optical filter such that the recognition of rainbow unevenness caused by external light, in particular, external light incident from the upper front side of the head can be suppressed.

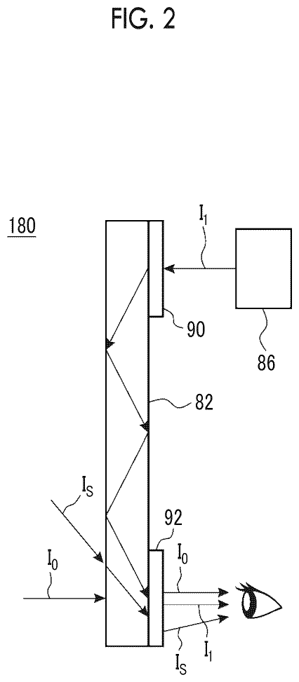

As shown in FIGS. 1 and 2, not only the background, that is, the front external light I₀ but also the external light I_{S} from the oblique direction are incident into the head-mounted display. In the following description, the external light incident from the oblique direction will also be referred to as the oblique external light I_{S}.

Here, as shown in FIG. 2, in a case where the oblique external light I_{S} is incident into a head-mounted display 180 in the related art not including the optical filter 10, The oblique external light I_{S} is diffracted by a diffraction element (in FIG. 2, the emission diffraction element 92), is emitted to an observation position, and is recognized by the user in a reflected glare state. Here, the diffraction angle by the diffraction element varies depending on wavelengths, that is, colors. Therefore, the oblique external light I_{S} diffracted by the diffraction element is dispersed and recognized as color unevenness such as rainbow, that is, so-called rainbow unevenness. In other words, the oblique external light I_{S} diffracted by the diffraction element is reflected on the video light I₁ as the rainbow unevenness.

Regarding this problem, particularly, rainbow unevenness caused by light such as sunlight or illumination light from a specific direction, specifically, from the upper front side of the head is likely to be recognized.

In order to suppress the recognition of the rainbow unevenness, in some AR glasses, by reducing the transmittance of the oblique external light I_{S} using an ND filter, the recognition of the rainbow unevenness caused by the incidence of the oblique external light I_{S} is suppressed.

However, in a case where the transmittance of light from the oblique direction is reduced to cut the external light from the oblique direction, the ND filter has a problem in that the transmittance of light from the front direction also decreases and the visibility of the front direction, that is, the background (front external light I₀) decreases.

On the other hand, in the optical device according to the embodiment of the present invention, the optical filter that covers the diffraction element and includes the anisotropic light absorbing layer, preferably, an optical filter that includes an anisotropic light absorbing layer 14 and the polarizer 12 is provided.

The optical device according to the embodiment of the present invention includes the optical filter 10 (10m). As a result, for use in a head-mounted display such as AR glasses, the transmittance of the front direction (front external light I₀) is high, that is, the visibility of the background is excellent, and rainbow unevenness caused by external light (oblique external light I_{S}) incident from the upper front side of the head (the front side in the upper oblique direction of the head) of the observer can be suppressed. Further, in the optical device according to the embodiment of the present invention, preferably, rainbow unevenness caused by external light incident not only from the upper front side of the head of the observer but also from the oblique upper front side of the head of the observer (the front side in the upper oblique direction of the head) can be suppressed.

The optical filter 10 and the optical filter 10m basically have the same configuration and exhibit the same effects. Therefore, in the following description, in a case where both of the optical filter 10 and the optical filter 10m do not need to be distinguished from each other, the optical filter 10 will be described as a representative example.

In the optical device according to the embodiment of the present invention, in the anisotropic light absorbing layer 14 configuring the optical filter 10, an angle between the absorption axis and the normal direction of the anisotropic light absorbing layer 14 is 0° to 45°. That is, the anisotropic light absorbing layer 14 has the absorption axis extending in the normal direction of the main surface of the anisotropic light absorbing layer 14 and the main surface of the light guide plate 82.

On the other hand, the polarizer 12 configuring the optical filter 10 has an absorption axis in the main surface. That is, the polarizer has the absorption axis parallel to the main surface of the anisotropic light absorbing layer 14 and the main surface of the light guide plate 82.

In the present invention, in a case where the optical filter includes the anisotropic light absorbing layer 14 and the polarizer 12, it is preferable that the anisotropic light absorbing layer 14 is disposed on the light guide plate 82 side from the viewpoint of improving light fastness.

Although not depending on the incidence direction of external light, the optical filter 10 acts, on external light incident into the light guide plate 82 from the oblique direction, as an absorption axis of a polarizer where the absorption axis of the anisotropic light absorbing layer 14 and the absorption axis of the polarizer 12 are disposed in a crossed nicols state.

That is, by providing the optical filter 10 corresponding to the diffraction element, the external light incident into the diffraction element from the oblique direction can be shielded (absorbed) by the optical filter 10.

In addition, the absorption axis of the anisotropic light absorbing layer 14 is a direction along the normal direction of the main surface of the anisotropic light absorbing layer 14. Therefore, the front external light I₀ incident from the front, that is, the background is not shielded in the anisotropic light absorbing layer 14.

As a result, in a case where the optical device according to the embodiment of the present invention is used for a head-mounted display such as AR glasses, the recognition of rainbow unevenness caused by external light (oblique external light I_{S}) incident from the oblique direction by the user can be suppressed while suitably maintaining the visibility of the background.

In the optical device according to the embodiment of the present invention, the diffraction element where the optical filter 10 is provided is not limited and can be freely selected. That is, in the optical device according to the embodiment of the present invention, the optical filter 10 may be provided in at least one of the diffraction elements.

Here, the external light that is likely to be rainbow unevenness is external light incident from the upper side of the head, in particular, external light incident from the upper front side of the head.

In consideration of this point, in the present invention, it is preferable that the optical filter is provided corresponding to the diffraction element where the slit direction is close to the horizontal direction. In particular, it is preferable that the optical filter is provided at least in a diffraction element where the slit direction is closest to the horizontal direction.

For example, in most cases, the incidence diffraction element 90 is disposed at a position where external light is not incident, for example, a place hidden by a temple. This way, regarding the diffraction element that is disposed at the position where external light is not incident, even in a case where the slit direction is close to the horizontal direction, the optical filter does not need to be provided.

In the present invention, the slit direction is a direction of a structure that generates diffraction in the diffraction element (diffraction grating). Examples of the structure that generates diffraction include a groove, a protrusion, a boundary between different liquid crystal alignment structures, a boundary between different refractive indices, and a boundary between different transmittances.

Specifically, in a case where the diffraction element is a diffraction element having a physical groove shape, for example, a surface relief type diffraction element or a holographic surface diffraction element, an extending direction (longitudinal direction) of the groove portion that forms the diffraction element is the slit direction.

In a case where the diffraction element is a diffraction element having a high refractive index region and a low refractive index region as in a transmissive volume phase holographic diffraction element, an extending direction of a boundary between the high refractive index region and the low refractive index region is the slit direction.

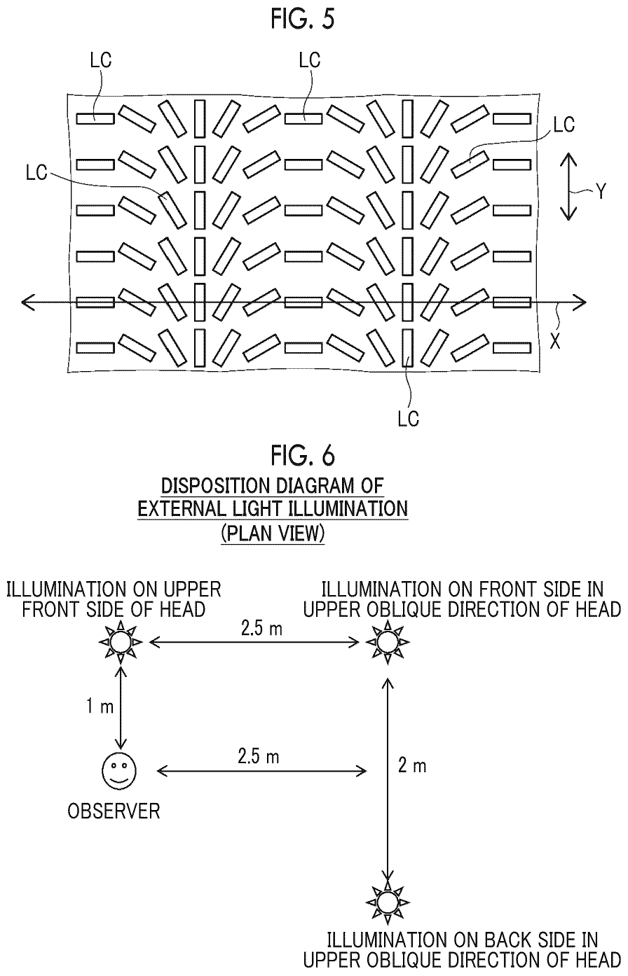

In a case where the diffraction element is a liquid crystal diffraction element, a direction in which an alignment direction of a liquid crystal compound is uniform in any plane of a thickness direction of the diffraction element is the slit direction. For example, as conceptually shown in FIG. 5, in a liquid crystal diffraction element having a liquid crystal alignment pattern where a liquid crystal compound LC continuously rotates in an arrow X direction, an Y direction that is orthogonal to the arrow X direction and in which an alignment direction of the liquid crystal compound LC is uniform is the slit direction.

In addition, in the present invention, the diffraction element where the slit direction is close to the horizontal direction refers to a diffraction element where the slit direction is close to the horizontal direction in a situation where AR glasses are appropriately worn and are appropriately used in a typical situation.

The slit direction being close to the horizontal direction represents that an angle between the horizontal direction and the slit direction is 30° or less.

The external light that is obliquely incident into the diffraction element of the AR glasses is likely to be external light incident into the AR glasses from the upper front side of the head, for example, sunlight or indoor illumination light. That is, in a case where this external light is diffracted by the diffraction element and is reaches the observation position by the user, rainbow unevenness is likely to occur.

Here, in the diffraction element where the slit direction is close to the horizontal direction, the external light incident from the upper front side of the head transmits through the light guide plate 82 and is likely to be diffracted in the direction of the observation position by the user. Therefore, in a case where the optical element according to the embodiment of the present invention includes a plurality of diffraction elements, it is preferable that the optical filter 10 is provided at least in a diffraction element where the slit direction is closest to the horizontal direction.

For example, as shown in FIG. 3, in a case where an angle of the slit direction of the incidence diffraction element 90 with respect to the horizontal direction is 126°, an angle of the slit direction of the intermediate diffraction element 94 with respect to the horizontal direction is 10°, and an angle of the slit direction of the emission diffraction element 92 with respect to the horizontal direction is 76°, it is preferable that the optical filter 10 (in FIG. 4, an optical filter 10e) is provided at least in the intermediate diffraction element 94.

This angle is an angle counterclockwise with respect to the horizontal direction as 0° as shown on the right side of FIG. 3. Accordingly, the diffraction element where the slit direction is closest to the horizontal direction is the diffraction element where the angle between the horizontal direction and the slit direction is closest to 0° or 180°.

Here, in the head-mounted display such as AR glasses including the optical device according to the embodiment of the present invention, the external light obliquely incident into the diffraction element is not limited to the external light incident from the upper front side of the head.

That is, external light is also incident into the diffraction element of the head-mounted display from the oblique upper side of the head (the front side in the upper oblique direction of the head).

In a case where the external light incident from the oblique upper side of the head into, for example, the diffraction element where the slit direction is close to the vertical direction, the external light transmits through the light guide plate 82, is diffracted in the direction of the observation position by the user, and is likely to be recognized as rainbow unevenness.

Accordingly, in the optical device according to the embodiment of the present invention, it is preferable that the optical filter 10 is provided not only in the diffraction element where the slit direction is closest to the horizontal direction but also in the other diffraction element.

For example, in the optical device shown in FIGS. 3 and 4, it is preferable that the optical filter 10 is also provided in the emission diffraction element 92 where the angle of the slit direction is 76° with respect to the horizontal direction.

As a result, not only rainbow unevenness caused by the external light incident from the upper front side of the head but also rainbow unevenness caused by the external light from the oblique upper side of the head (the front side in the upper oblique direction of the head) can be suppressed.

In the above-described example, in a preferable aspect, the optical filter 10 is provided on the opposite observation surface of the light guide plate 82 opposite to the observation surface side (user side). With this configuration, the video light that is guided in the light guide plate 82, is diffracted by the emission diffraction element 92, and is emitted from the light guide plate 82 can be suppressed from being absorbed by the optical filter 10.

On the other hand, in the head-mounted display, there may also be a case where the external light incident from the observation surface side of the light guide plate 82, that is, from the back side of the observer is reflected from an edge, a temple, or the like of the AR glasses, is reflected from the diffraction element, and is recognized as rainbow unevenness.

Accordingly, in a case where the suppression of rainbow unevenness is important depending on the use of the head-mounted display and the like, an optical filter may be provided on both surfaces of the light guide plate to cover one or more diffraction elements. As a result, rainbow unevenness caused by not only the external light obliquely incident from the front side of the user but also the external light obliquely incident from the back side of the user can be suppressed.

As described above, in the optical device according to the embodiment of the present invention, as the diffraction element, not only the transmissive diffraction element shown in FIG. 1 and the like but also a reflective diffraction element can be used.

In this case, the diffraction element is provided on the surface of the light guide plate 82 opposite to the observation surface side (user side), that is, on the opposite observation surface side. Therefore, in a case where the diffraction element is a reflective type, it is preferable that the optical filter 10 is laminated and provided on the diffraction element instead of the surface of the light guide plate.

In the optical filter of the optical device according to the embodiment of the present invention, the angle between the absorption axis of the anisotropic light absorbing layer 14 of the optical filter 10 and the normal line of the main surface of the anisotropic light absorbing layer 14 is 0° to 45°. This angle does not have a relationship with the orientation direction, and is an absolute value of an angle (polar angle) between the absorption axis of the anisotropic light absorbing layer 14 and the normal line of the main surface.

In a case where the angle between the absorption axis of the anisotropic light absorbing layer 14 and the normal line of the main surface of the anisotropic light absorbing layer 14 exceeds 45°, there is an inconvenience in that, for example, the oblique external light I_{S} cannot be appropriately shielded (absorbed), the recognition of rainbow unevenness cannot be suppressed, and the visibility of the background deteriorates due to unnecessarily shielding of the front external light I₀ incident from the front side.

The angle between the absorption axis of the anisotropic light absorbing layer 14 of the optical filter 10 and the normal line of the main surface of the anisotropic light absorbing layer 14 is preferably 0° to 30°, more preferably 0° to 15°, and still more preferably 0° to 10°.

In addition, in a case where the optical filter 10 includes the polarizer 12, the angle between the slit direction of the diffraction element and the absorption axis of the polarizer 12 of the optical filter 10 corresponding to (covering) the diffraction element is preferably 0° to 45°. In particular, the angle between the slit direction of the diffraction element where the slit direction is closest to the horizontal direction and the absorption axis of the polarizer 12 of the corresponding optical filter 10 is preferably 0° to 45°.

This configuration is preferable from the viewpoint that the oblique external light I_{S} causing rainbow unevenness can be more suitably shielded (absorbed).

The angle between the absorption axis of the polarizer 12 and the slit direction of the corresponding diffraction element is more preferably 0° to 30° and still more preferably 0° to 15°.

For example, as shown in FIGS. 3 and 4, in a case where the optical device (head-mounted display) according to the embodiment of the present invention includes the intermediate diffraction element 94 in addition to the incidence diffraction element 90 and the emission diffraction element 92, the slit direction typically varies between the emission diffraction element 92 and the intermediate diffraction element 94.

In this case, an angle between the absorption axis of the polarizer 12 of the optical filter 10 covering the emission diffraction element 92 and the slit direction of the emission diffraction element 92 is preferably 0° to 45°, and an angle between the absorption axis of the polarizer 12 of the optical filter 10m covering the intermediate diffraction element 94 and the slit direction of the intermediate diffraction element 94 is preferably 0° to 45°.

Further, it is preferable that the direction of the absorption axis varies between the polarizer 12 of the optical filter 10 covering the emission diffraction element 92 and the polarizer 12 of the optical filter 10 covering the intermediate diffraction element 94.

### Optical Filter

Hereinafter, the optical filter in the optical device according to the embodiment of the present invention will be described in detail.

As described above, in the optical device according to the embodiment of the present invention, the optical filter includes the anisotropic light absorbing layer. In addition, in the anisotropic light absorbing layer, the angle between the absorption axis and the normal direction of the main surface of the anisotropic light absorbing layer is 0° to 45°.

In addition, in the optical device according to the embodiment of the present invention, it is preferable that the optical filter includes a polarizer having an absorption axis in a main surface in addition to the anisotropic light absorbing layer.

### <Anisotropic Light Absorbing Layer>

The anisotropic light absorbing layer includes a dichroic colorant, and an angle between an absorption axis of the dichroic colorant and the normal line of the main surface is 0° to 45°.

By aligning the absorption axis of the anisotropic light absorbing layer to be substantially perpendicular to the main surface, the transmittance of light incident from the front side is high, and the transmittance of light from an oblique direction is low because only S-polarized light can transmit through the anisotropic light absorbing layer.

On the other hand, by aligning the absorption axis of the anisotropic light absorbing layer to be parallel to the main surface, an anisotropic light absorbing layer having the same optical performance as an iodine-based polarizer that is generally known can be obtained, the iodine-based polarizer being obtained by impregnating a polyvinyl alcohol (PVA) stretched film with polyiodide ions.

Here, the alignment of the absorption axis of the anisotropic light absorbing layer substantially in the direction perpendicular to the main surface (horizontal reference surface) can be verified, for example, by observing a cross section of the anisotropic light absorbing layer with a transmission electron microscope (TEM).

A technique for aligning a dichroic colorant as desired can refer to a technique of preparing a polarizer using a dichroic colorant, a technique of preparing a guest-host liquid crystal cell, and the like.

For example, techniques used in a method of preparing a dichroic polarizer described in JP2002-90526A and a method of preparing a guest-host type liquid crystal display device described in JP2002-99388A can be used for preparing the anisotropic light absorbing layer used in the present invention.

The dichroic colorant can be classified into a dichroic colorant having a rod-like molecular shape and a dichroic colorant having a disk-like molecular shape. Any of the dichroic colorants may be used for preparing the anisotropic light absorbing layer used in the present invention.

Preferable examples of the dichroic colorant including rod-like molecules include an azo colorant, an anthraquinone colorant, a perylene colorant, and a merocyanine colorant. Examples of the azo colorant include examples described in JP1999-172252A (JP-H11-172252A), examples of the anthraquinone colorant include examples described in JP1996-67822A (JP-H8-67822A), examples of the perylene colorant include examples described in JP1987-129380A (JP-S62-129380A), and examples of the merocyanine colorant examples described in JP2002-241758A. These colorants may be used alone or in combination of two or more kinds thereof.

In addition, examples of the dichroic colorant including disk-like molecules include lyotropic liquid crystal represented by OPTIVA Inc., which is known as “E-Type polarizer”. For example, materials described in JP2002-90547A can be used.

In addition, there is also an example of using a bis azo-based dichroic colorant having a thread-like micelle type structure as a chemical structure that absorbs light in a disk shape, and materials described in JP2002-90526A can be used.

These colorants may be used alone or in combination of two or more kinds thereof.

In the case of “E-Type polarizer” using the disk-like dichroic colorant, oblique external light can be shielded without using the polarizer having an absorption axis in a main surface in combination.

In the present invention, from the viewpoint of easily obtaining a high alignment degree, the rod-like dichroic colorant is preferably used.

For example, the molecules of the dichroic colorant can be desirably aligned as described above in association with the alignment of host liquid crystals using the technique of the guest-host type liquid crystal cell.

Specifically, the anisotropic light absorbing layer used in the present invention can be prepared by mixing a dichroic colorant serving as a guest and a rod-like liquid crystal compound serving as a host liquid crystal, aligning the host liquid crystal, aligning molecules of the dichroic colorant along the alignment of the liquid crystal molecules, and immobilizing the alignment state.

In order to prevent fluctuation of light absorbing characteristics of the anisotropic light absorbing layer used in the present invention depending on the use environment, it is preferable that the alignment of the dichroic colorant is immobilized by forming a chemical bond.

For example, the alignment can be immobilized by promoting polymerization of the host liquid crystals, the dichroic colorant, and an optionally added polymerizable component.

In the optical device according to the embodiment of the present invention, the anisotropic light absorbing layer in the optical filter is an anisotropic light absorbing layer in the dichroic colorant. The anisotropic light absorbing layer is preferably an anisotropic light absorbing layer including a liquid crystal compound together with the dichroic colorant and more preferably a layer obtained by immobilizing the alignment state of the liquid crystal compound and the dichroic colorant.

In addition, an angle between a transmittance central axis of the anisotropic light absorbing layer and the normal direction of the surface of the anisotropic light absorbing layer is 0° to 45°, preferably 0° or more and less than 45°, more preferably 0° to 35°, and still more preferably 0° or more and less than 35°.

### <Dichroic Colorant>

In the present invention, the dichroic colorant (dichroic substance) refers to a colorant having different absorbances depending on directions. The dichroic colorant may or may not be liquid crystalline.

The dichroic colorant is not particularly limited, and examples thereof include a visible light absorbing material, a light emitting material (a fluorescent material or a phosphorescent material), an ultraviolet absorbing material, an infrared absorbing material, a nonlinear optical material, carbon nanotube, and an inorganic material (for example, a quantum rod). Well-known dichroic colorants in the related art can be used.

Specific examples thereof include those described in paragraphs [0067] to [0071] of JP2013-228706A, paragraphs [0008] to [0026] of JP2013-227532A, paragraphs [0008] to [0015] of JP2013-209367A, paragraphs [0045] to [0058] of JP2013-14883A, paragraphs [0012] to [0029] of JP2013-109090A, paragraphs [0009] to [0017] of JP2013-101328A, paragraphs [0051] to [0065] to of JP2013-37353A, paragraphs [0049] to [0073] of JP2012-63387A, paragraphs [0016] to [0018] of JP1999-305036A (JP-H11-305036A), paragraphs [0009] to [0011] of JP2001-133630A, paragraphs [0030] to [0169] of JP2011-215337A, paragraphs [0021] to [0075] of JP2010-106242A, paragraphs [0011] to [0025] of JP2010-215846A, paragraphs [0017] to [0069] of JP2011-048311A, paragraphs [0013] to [0133] of JP2011-213610A, paragraphs [0074] to [0246] of JP2011-237513A, paragraphs [0005] to [0051] of JP2016-006502A, paragraphs [0014] to [0032] to of JP2018-053167A, paragraphs [0014] to [0033] of JP2020-11716A, paragraphs [0005] to [0041] of WO2016/060173A, paragraphs [0008] to [0062] of WO2016/136561A, paragraphs [0014] to [0033] of WO2017/154835A, paragraphs [0014] to [0033] of WO2017/154695A, paragraphs [0013] to [0037] of WO2017/195833A, paragraphs [0014] to [0034] of WO2018/164252A, paragraphs [0021] to [0030] of WO2018/186503A, paragraphs [0043] to [0063] of WO2019/189345A, paragraphs [0043] to [0085] of WO2019/225468A, paragraphs [0050] to [0074] of WO2020/004106A, and paragraphs [0015] to [0038] of WO2021/044843A.

As the dichroic colorant, a dichroic azo colorant compound is preferable.

The dichroic azo colorant compound refers to an azo colorant compound of which an absorbance varies depending on directions. The dichroic azo colorant compound may or may not exhibit liquid crystallinity. In a case where the dichroic azo colorant compound exhibits liquid crystallinity, the dichroic azo colorant compound may exhibit any of nematic liquid crystallinity or smectic liquid crystallinity. A temperature range where a liquid crystal phase is exhibited is preferably room temperature (about 20° C. to 28° C.) to 300° C. and more preferably 50° C. to 200° C. from the viewpoints of handleability and manufacturing suitability.

In the present invention, from the viewpoint of adjusting the tint, it is preferable that at least one colorant compound (first dichroic azo colorant compound) having a maximal absorption wavelength in a wavelength range of 560 to 700 nm and at least one colorant compound (second dichroic azo colorant compound) having a maximal absorption wavelength in a wavelength range of 455 nm or more and less than 560 nm are at least used.

In the present invention, three or more kinds of dichroic azo colorant compounds may be used in combination. For example, from the viewpoint of approximating the anisotropic light absorbing layer to black, it is preferable that the first dichroic azo colorant compound, the second dichroic azo colorant compound, and at least one colorant compound (third dichroic azo colorant compound) having a maximal absorption wavelength in a wavelength range of 380 nm or more and less than 455 nm are used in combination.

In the present invention, it is preferable that the dichroic azo colorant compound has a crosslinkable group.

Examples of the crosslinkable group include a (meth) acryloyl group, an epoxy group, an oxetanyl group, and a styryl group. Among these, a (meth) acryloyl group is preferable.

The content of the dichroic colorant is not particularly limited, and from the viewpoint of increasing the alignment degree of the anisotropic light absorbing layer to be formed, is preferably 3 mass % or more, more preferably 8 mass % or more, still more preferably 10 mass % or more, and still more preferably 10 to 30 mass % with respect to the total mass of the anisotropic light absorbing layer. In a case where a plurality of dichroic colorants are used in combination, the total content of the plurality of dichroic colorants is preferably in the above-described range.

### <Liquid Crystal Compound>

It is preferable that the anisotropic light absorbing layer includes a liquid crystal compound. As a result, the dichroic colorant can be aligned with a high alignment degree while suppressing precipitation of the dichroic colorant.

As the liquid crystal compound, both a polymer liquid crystal compound and a low-molecular-weight liquid crystal compound can be used, and from the viewpoint of increasing the alignment degree, a polymer liquid crystal compound is preferable. In addition, the polymer liquid crystal compound and the low-molecular-weight liquid crystal compound may be used in combination as the liquid crystal compound.

Here, “polymer liquid crystal compound” refers to a liquid crystal compound including a repeating unit in a chemical structure.

In addition, “low-molecular-weight liquid crystal compound” refers to a liquid crystal compound not including a repeating unit in a chemical structure.

Examples of the polymer liquid crystal compound include thermotropic liquid crystalline polymers described in JP2011-237513A and polymer liquid crystal compounds described in paragraphs to of WO2018/199096A.

Examples of the low-molecular-weight liquid crystal compound include liquid crystal compounds described in paragraphs to of JP2013-228706A, and among these, a liquid crystal compound exhibiting smectic properties is preferable.

Here, examples of the smectic phase include a smectic A phase and a smectic C phase, and a higher-order smectic phase (such as a smectic B phase, a smectic E phase, a smectic F phase, a smectic G phase, a smectic H phase, a smectic I phase, a smectic J phase, a smectic K phase, and a smectic L phase) may also be employed.

In addition, the liquid crystal compound may exhibit a nematic phase in addition to the smectic phase.

In the present invention, from the reason that the contrast is higher, it is preferable that the liquid crystal compound is a liquid crystal compound exhibiting any liquid crystal state of a smectic B phase, a smectic E phase, a smectic F phase, a smectic G phase, a smectic H phase, a smectic I phase, a smectic J phase, a smectic K phase, or a smectic L phase.

As the smectic liquid crystal compound, a compound represented by Formula (A-1) is preferable.

Q1-V1-SP1-X1-(Ma-La)na-X2-SP2-V2-Q2 Formula (A-1)

In Formula (A-1), Q1 and Q2 each independently represent a polymerizable group.

In addition, V1, V2, X1, and X2 each independently represent a single bond or a divalent linking group.

In addition, SP1 and SP2 each independently represent a divalent spacer group.

In addition, Ma represents an aromatic ring, an aliphatic ring, or a heterocyclic ring, which may have a substituent.

Note that a plurality of Ma's may be the same or different from each other.

In addition, La represents a single bond or a divalent linking group. Note that a plurality of La's may be the same or different from each other.

In addition, na represents an integer of 2 to 10.

As the polymerizable group represented by Q1 and Q2, a polymerizable group which is radically polymerizable (radically polymerizable group) or a polymerizable group which is cationically polymerizable (cationically polymerizable group) is preferable.

As the radically polymerizable group, a known radically polymerizable group can be used, and an acryloyloxy group or a methacryloyloxy group is preferable. It has been known that the acryloyloxy group tends to have a high polymerization rate, and the acryloyloxy group is preferable from the viewpoint of improving productivity, but the methacryloyloxy group can also be used as the polymerizable group.

As the cationically polymerizable group, a known cationically polymerizable group can be used, and examples thereof include an alicyclic ether group, a cyclic acetal group, a cyclic lactone group, a cyclic thioether group, a spiroorthoester group, and a vinyloxy group. Among these, an alicyclic ether group or a vinyloxy group is preferable, and an epoxy group, an oxetanyl group, or a vinyloxy group is more preferable.

Preferable examples of the polymerizable group include polymerizable groups represented by Formulae (P-1) to (P-30).

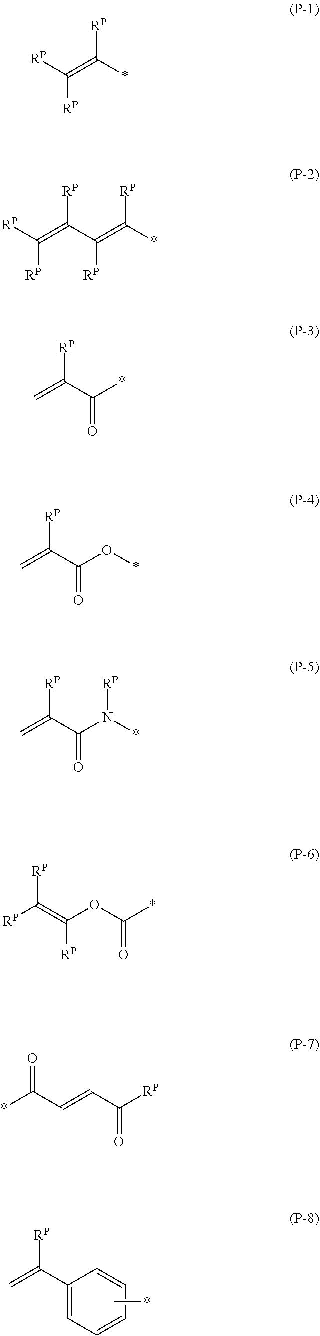

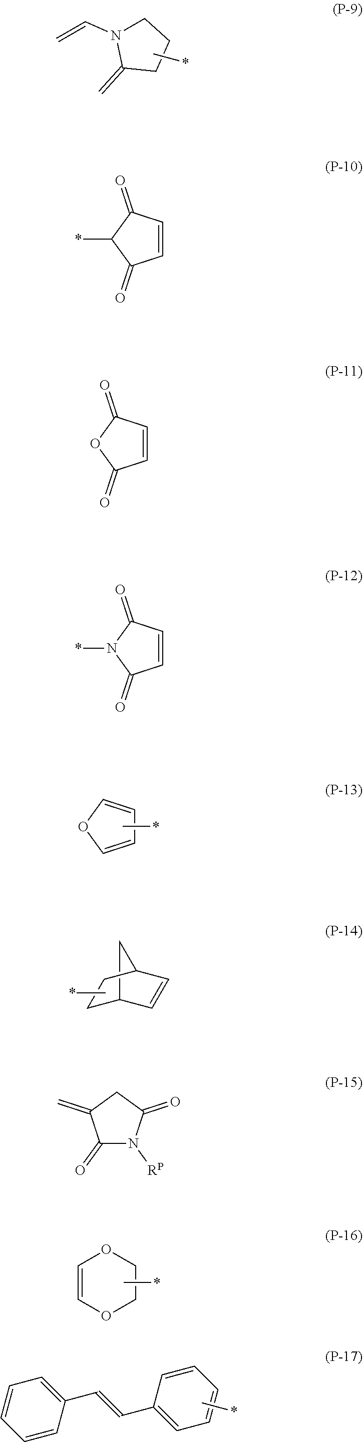

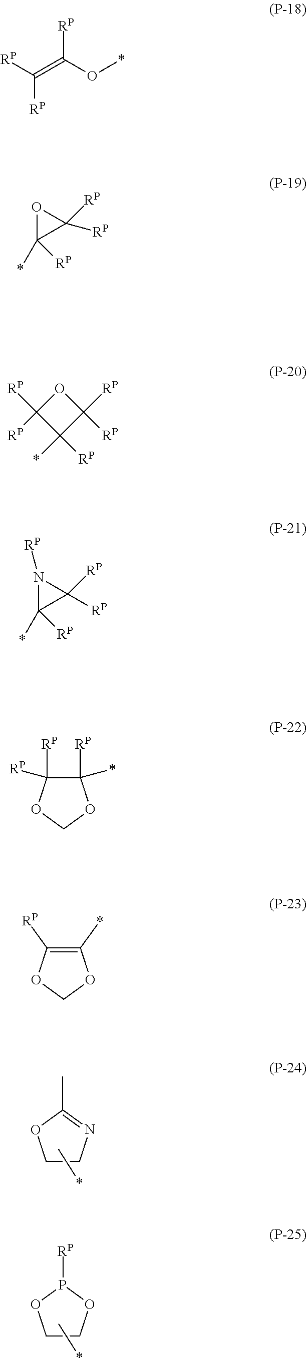

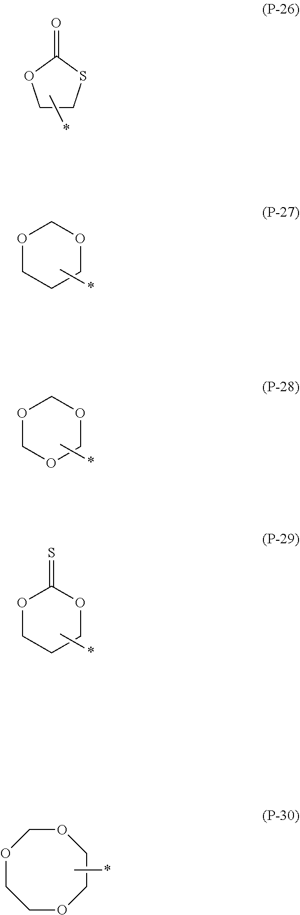

In Formulae (P-1) to (P-30), RP represents a hydrogen atom, a halogen atom, a linear, branched, or cyclic alkylene group having 1 to 10 carbon atoms, a halogenated alkyl group having 1 to 20 carbon atoms, an alkoxy group having 1 to 20 carbon atoms, an alkenyl group having 1 to 20 carbon atoms, an alkynyl group having 1 to 20 carbon atoms, an aryl group having 1 to 20 carbon atoms, a heterocyclic group (also referred to as a heterocyclic ring group), a cyano group, a hydroxy group, a nitro group, a carboxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an ammonio group, an acylamino group, an aminocarbonylamino group, an alkoxycarbonylamino group, an aryloxycarbonylamino group, a sulfamoylamino group, an alkyl or arylsulfonylamino group, a mercapto group, an alkylthio group, an arylthio group, a heterocyclic thio group, a sulfamoyl group, a sulfo group, an alkyl or arylsulfinyl group, an alkyl or arylsulfonyl group, an acyl group, an aryloxycarbonyl group, an alkoxycarbonyl group, a carbamoyl group, an aryl or heterocyclic azo group, an imide group, a phosphino group, a phosphinyl group, a phosphinyloxy group, a phosphinylamino group, a phosphono group, a silyl group, a hydrazino group, a ureido group, a boronic acid group (—B(OH)₂), a phosphate group (—OPO(OH)₂), or a sulfate group (—OSO₃H). A plurality of R^{P}'s may be the same or different from each other.

Among these, as the radically polymerizable group, the vinyl group represented by Formula (P-1), the butadiene group represented by Formula (P-2), the (meth) acryloyloxy group represented by Formula (P-4), the (meth) acrylamide group represented by Formula (P-5), the vinyl acetate group represented by Formula (P-6), the fumaric acid ester group represented by Formula (P-7), the styryl group represented by Formula (P-8), the vinylpyrrolidone group represented by Formula (P-9), the maleic acid anhydride represented by Formula (P-11), or the maleimide group represented by Formula (P-12) is preferable; and as the cationically polymerizable group, the vinyl ether group represented by Formula (P-18), the epoxy group represented by Formula (P-19), or the oxetanyl group represented by Formula (P-20) is preferable.

In Formula (A-1), examples of the divalent linking group represented by one aspect of V1, V2, X1, X2, and La include —O—, —(CH₂)_{g}—, —(CF₂)_{g}—, —Si(CH₃)₂—, —(Si(CH₃)₂O)_{g}—, —(OSi(CH₃)₂)_{g}— (g represents an integer of 1 to 10), —N(Z)—, —C(Z)═C(Z′)—, —C(Z)═N—, —N═C (Z)—, —C(Z)₂—C(Z′)₂—, —C(O)—, —OC(O)—, —C(O)O—, —O—C(O)O—, —N(Z)C(O)—, —C(O)N(Z)—, —C(Z)═C (Z′)—C(O)O—, —O—C(O)—C(Z)═C(Z′)—, —C(Z)═N—, —N═C(Z)—, —C(Z)═C(Z′)—C(O)N(Z″)—, —N(Z″)—C(O)—C(Z)═C(Z′)—, —C(Z)═C(Z′)—C(O)—S—, —S—C(O)—C(Z)═C(Z′)—, —C(Z)═N—N═C(Z′)— (Z, Z′, and Z″ independently represent hydrogen, an alkyl group having 1 to 4 carbon atoms, a cycloalkyl group, an aryl group, a cyano group, or a halogen atom), —C≡C—, —N═N—, —S—, —S(O)—, —S(O)(O)—, —(O)S(O)O—, —O(O)S(O)O—, —SC(O)—, and —C(O)S—. V1, V2, X1, X2, and La may represent a group obtained by combining two or more of these groups.

In Formula (A-1), examples of the divalent spacer group represented by SP1 and SP2 include a linear, branched, or cyclic alkylene group having 1 to 50 carbon atoms and a heterocyclic group having 1 to 20 carbon atoms.

The carbon atoms of the alkylene group and the heterocyclic group may be substituted with —O—, —Si(CH₃)₂—, —(Si(CH₃)₂O)_{g}—, —(OSi(CH₃)₂)_{g}— (g represents an integer of 1 to 10), —N(Z)—, —C(Z)═C (Z′)—, —C(Z)═N—, —N═C (Z)—, —C(Z)₂—C(Z′)₂—, —C(O)—, —OC(O)—, —C(O)O—, —O—C(O)O—, —N(Z)C(O)—, —C(O)N(Z)—, —C(Z)═C(Z′)—C(O)O—, —O—C(O)—C(Z)═C (Z′)—, —C(Z)═N—, —N═C(Z)—, —C(Z)═C(Z′)—C(O)N(Z″)—, —N(Z″)—C(O)—C(Z)═C (Z′)—, —C(Z)═C (Z′)—C(O)—S—, —S—C(O)—C(Z)═C(Z′)—, —C(Z)═N—N═C(Z′)— (here, Z, Z′, and Z″ each independently represent hydrogen, an alkyl group having 1 to 4 carbon atoms, a cycloalkyl group, an aryl group, a cyano group, or a halogen atom), —C≡C—, —N═N—, —S—, —C(S)—, —S(O)—, —SO2—, —(O)S(O)O—, —O(O)S(O)O—, —SC(O)—, —C(O)S—, or a group obtained by combining two or more of these groups.

The hydrogen atom of the above-described alkylene group or the hydrogen atom of the heterocyclic group may be substituted with a halogen atom, a cyano group, —Z^{H}, —OH, —OZ^{H}, —COOH, —C(O)Z^{H}, —C(O)OZ^{H}, —OC(O)Z^{H}, —OC(O)OZ^{H}, —NZ^{H}Z^{H}′, —NZ^{H}C(O)Z^{H}′, —NZ^{H}C(O)OZ^{H}′, —C(O)NZ^{H}Z^{H}′, —OC(O)NZ^{H}Z^{H}′, —NZ^{H}C(O)NZ^{H}′OZ^{H}″, —SH, —SZ^{H}, —C(S)Z^{H}, —C(O)SZ^{H}, or —SC(O)Z^{H}. Here, Z^{H}, Z^{H}′, and Z″ each independently represent an alkyl group having 1 to 10 carbon atoms, a halogenated alkyl group, or -L-Q (L represents a single bond or a divalent linking group. Specific examples of the divalent linking group are the same as those for V1 described above. Q represents a crosslinkable group, examples of the crosslinkable group include the polymerizable group represented by Q1 or Q2. Among these, polymerizable groups represented by Formulae (P-1) to (P-30) are preferable).

In Formula (A-1), MA represents an aromatic ring, an aliphatic ring, or a heterocyclic ring, which may have a substituent and preferably a 4- to 15-membered ring. MA may represent a monocyclic ring or a fused ring, and a plurality of MA's may be the same or different from each other.

Examples of the aromatic ring represented by MA include a phenylene group, a naphthylene group, a fluorene-diyl group, an anthracene-diyl group, and a tetracene-diyl group. From the viewpoint of design diversity of the mesogenic skeleton and the availability of raw materials, a phenylene group or a naphthylene group is preferable.

Specific examples of the aliphatic ring represented by MA include a cyclopentylene group and a cyclohexylene group, and carbon atoms thereof may be substituted with —O—, —Si(CH₃)₂—, —N(Z)—, —C(O)—, (Z represents hydrogen, an alkyl group having 1 to 4 carbon atoms, a cycloalkyl group, an aryl group, a cyano group, or a halogen atom), —S—, —C(S)—, —S(O)—, —SO₂—, or a group obtained by combining two or more of these groups.

Examples of atoms other than carbon forming the heterocyclic ring represented by MA include a nitrogen atom, a sulfur atom, and an oxygen atom. In a case where the heterocyclic group has a plurality of atoms forming the ring other than carbon, the atoms may be the same as or different from each other. Specific examples of the heterocycle include a pyridylene group (pyridine-diyl group), a pyridazine-diyl group, an imidazole-diyl group, thienylene (thiophene-diyl group), a quinolylene group (quinoline-diyl group), an isoquinolylene group (isoquinoline-diyl group), an oxazole-diyl group, a thiazole-diyl group, an oxadiazole-diyl group, a benzothiazole-diyl group, a benzothiadiazole-diyl group, a phthalimido-diyl group, a thienothiazole-diyl group, a thiazolothiazole-diyl group, a thienothiophene-diyl group, a thienooxazole-diyl group, and the following structures (II-1) to (II-4).

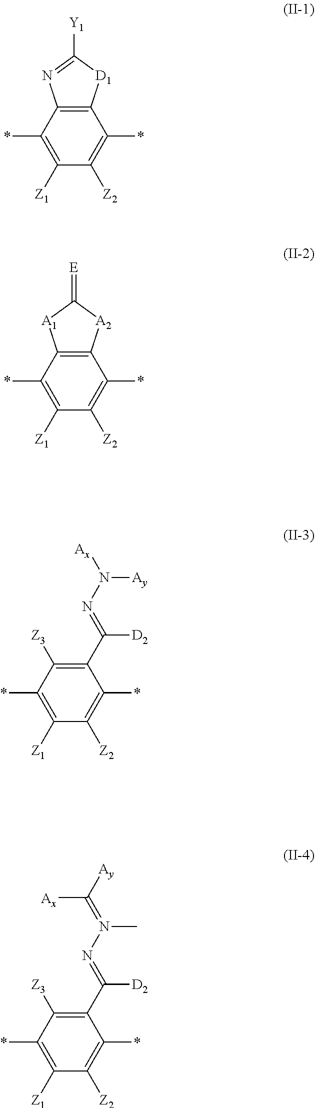

In Formulae (II-1) to (II-4), D₁ represents —S—, —O—, or NR¹¹—, and R¹¹ represents a hydrogen atom or an alkyl group having 1 to 6 carbon atoms.

Y₁ represents an aromatic hydrocarbon group having 6 to 12 carbon atoms or an aromatic heterocyclic group having 3 to 12 carbon atoms.

Z₁, Z₂, and Z₃ each independently represent a hydrogen atom, an aliphatic hydrocarbon group having 1 to 20 carbon atoms, an alicyclic hydrocarbon group having 3 to 20 carbon atoms, a monovalent aromatic hydrocarbon group having 6 to 20 carbon atoms, a halogen atom, a cyano group, a nitro group, —NR¹²R¹³, or SR¹². Here, Z¹ and Z² may be bonded to each other to form an aromatic ring or an aromatic heterocyclic ring, and R¹² and R¹³ each independently represent a hydrogen atom or an alkyl group having 1 to 6 carbon atoms.

A₁ and A₁₂ each independently represent a group selected from the group consisting of —O—, —NR²¹— (R²¹ represents a hydrogen atom or a substituent), —S—, and —CO—.

E represents a non-metal atom of Group 14 to Group 16, to which a hydrogen atom or a substituent may be bonded.

Ax represents an organic group having 2 to 30 carbon atoms, which has at least one aromatic ring selected from the group consisting of an aromatic hydrocarbon ring and an aromatic heterocyclic ring.

Ay represents a hydrogen atom, an alkyl group having 1 to 6 carbon atoms, which may have a substituent, or an organic group having 2 to 30 carbon atoms, which has at least one aromatic ring selected from the group consisting of an aromatic hydrocarbon ring and an aromatic heterocyclic ring, in which the aromatic rings of Ax and Ay may have a substituent and Ax and Ay may be bonded to each other to form a ring.

D₂ represents a hydrogen atom or an alkyl group having 1 to 6 carbon atoms, which may have a substituent.

In Formula (II-2), in a case where Y₁ represents an aromatic hydrocarbon group having 6 to 12 carbon atoms, the aromatic hydrocarbon group may be monocyclic or polycyclic. In a case where Y₁ represents an aromatic heterocyclic group having 3 to 12 carbon atoms, the aromatic heterocyclic group may be monocyclic or polycyclic.

In Formula (II-2), in a case where A₁ and A₂ represent —NR²¹—, the substituent as R²¹ can refer to, for example, description in paragraphs 0035 to 0045 of JP2008-107767A, the content of which is incorporated in the present specification.

In Formula (II-2), in a case where X represents a non-metal atom of Group 14 to Group 16, to which a substituent may be bonded, ═O, ═S, ═NR′, or ═C(R′)R′ is preferable. R′ represents a substituent, as the substituent, for example, the description in paragraphs [0035] to [0045] of JP2008-107767A can be referred to, and a nitrogen atom is preferable.

Examples of the substituent that an aromatic ring, an aliphatic ring, or a heterocyclic ring as MA in Formula (A-1) may have include a halogen atom, an alkyl group having 1 to 20 carbon atoms, a halogenated alkyl group having 1 to 20 carbon atoms, a cycloalkyl group having 1 to 20 carbon atoms, an alkoxy group having 1 to 20 carbon atoms, an alkenyl group having 1 to 20 carbon atoms, an alkynyl group having 1 to 20 carbon atoms, an aryl group having 1 to 20 carbon atoms, a heterocyclic group, a cyano group, a hydroxy group, a nitro group, a carboxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an ammonio group, an acylamino group, an aminocarbonylamino group, an alkoxycarbonylamino group, an aryloxycarbonylamino group, a sulfamoylamino group, an alkyl or arylsulfonylamino group, a mercapto group, an alkylthio group, an arylthio group, a heterocyclic thio group, a sulfamoyl group, a sulfo group, an alkyl or arylsulfinyl group, an alkyl or arylsulfonyl group, an acyl group, an aryloxycarbonyl group, an alkoxycarbonyl group, a carbamoyl group, an aryl or heterocyclic azo group, an imide group, a phosphino group, a phosphinyl group, a phosphinyloxy group, a phosphinylamino group, a phosphono group, a silyl group, a hydrazino group, a ureido group, a boronic acid group (—B(OH)₂), a phosphate group (—OPO(OH)₂), a sulfate group (—OSO₃H), and other known substituents.

The details of the substituent are described in paragraph of [0023] JP2007-234651A.

In Formula (A-1), na represents an integer of 2 to 10 and more preferably an integer of 2 to 8.

Examples of the smectic liquid crystal compound include compounds described in paragraphs [0033] to [0039] of JP2008-19240A, paragraphs [0037] to [0041] of JP2008-214269A, and paragraphs [0033] to [0040] of JP2006-215437A, and structures shown below, but the smectic liquid crystal compound is not limited thereto.

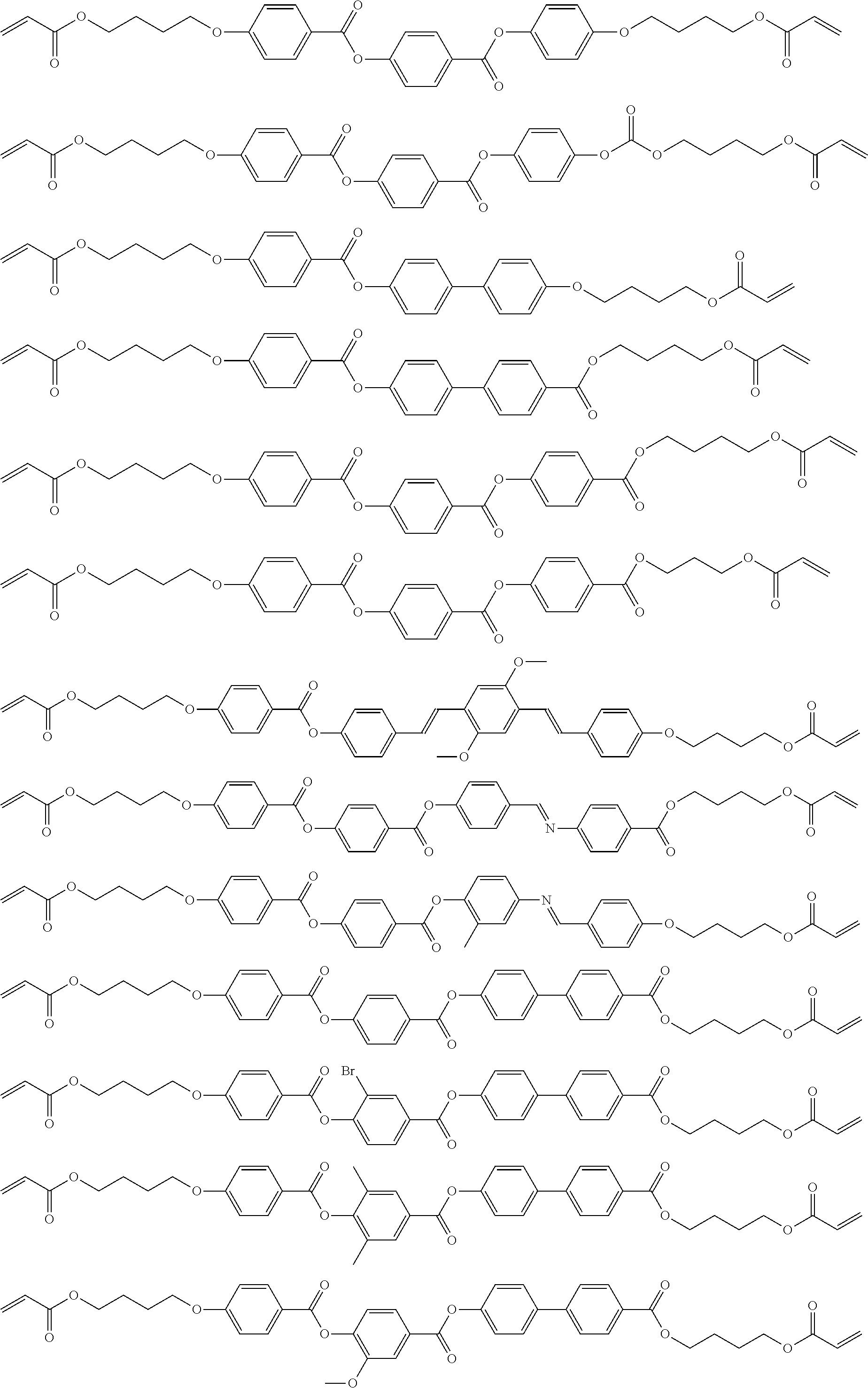

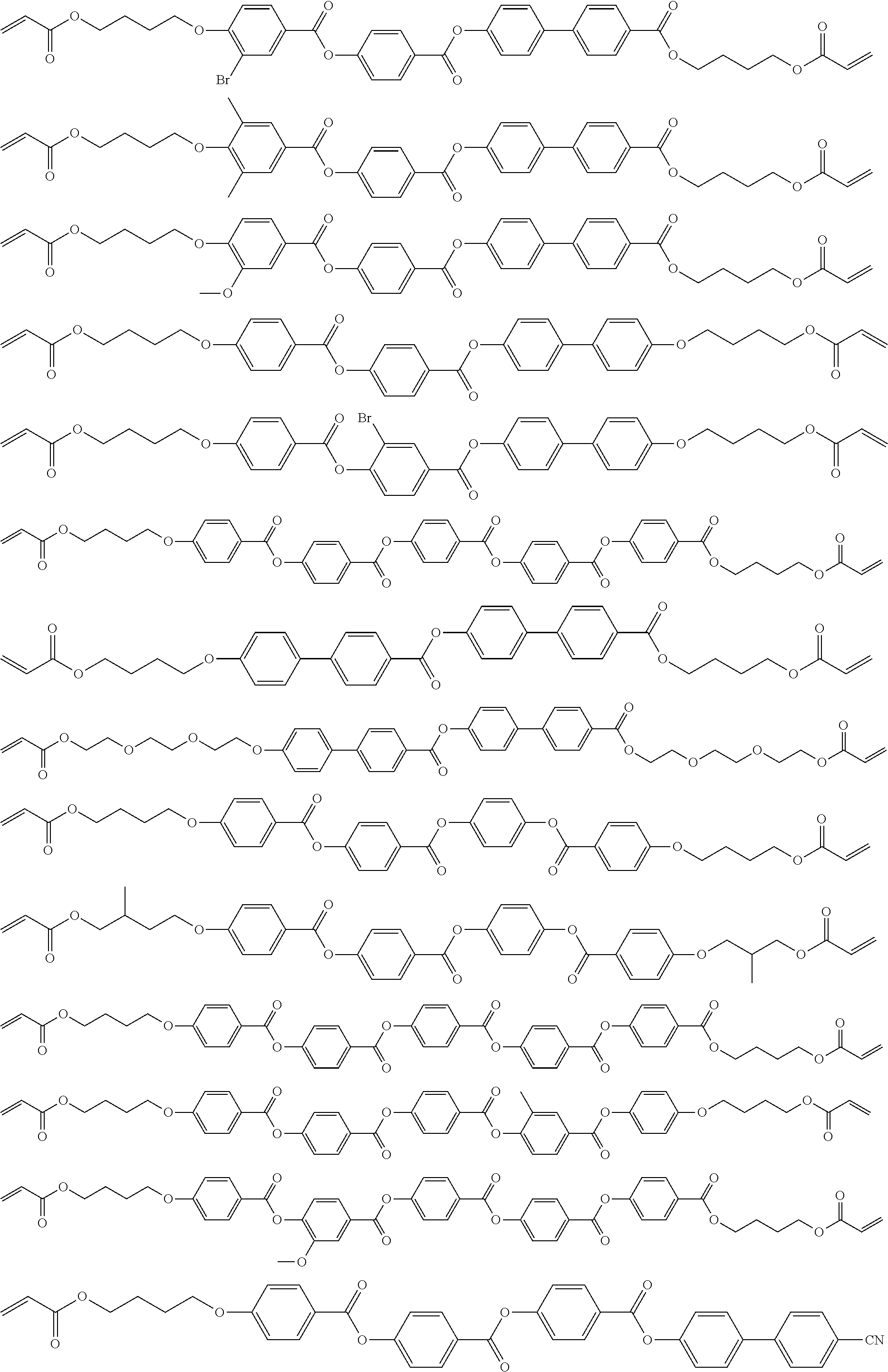

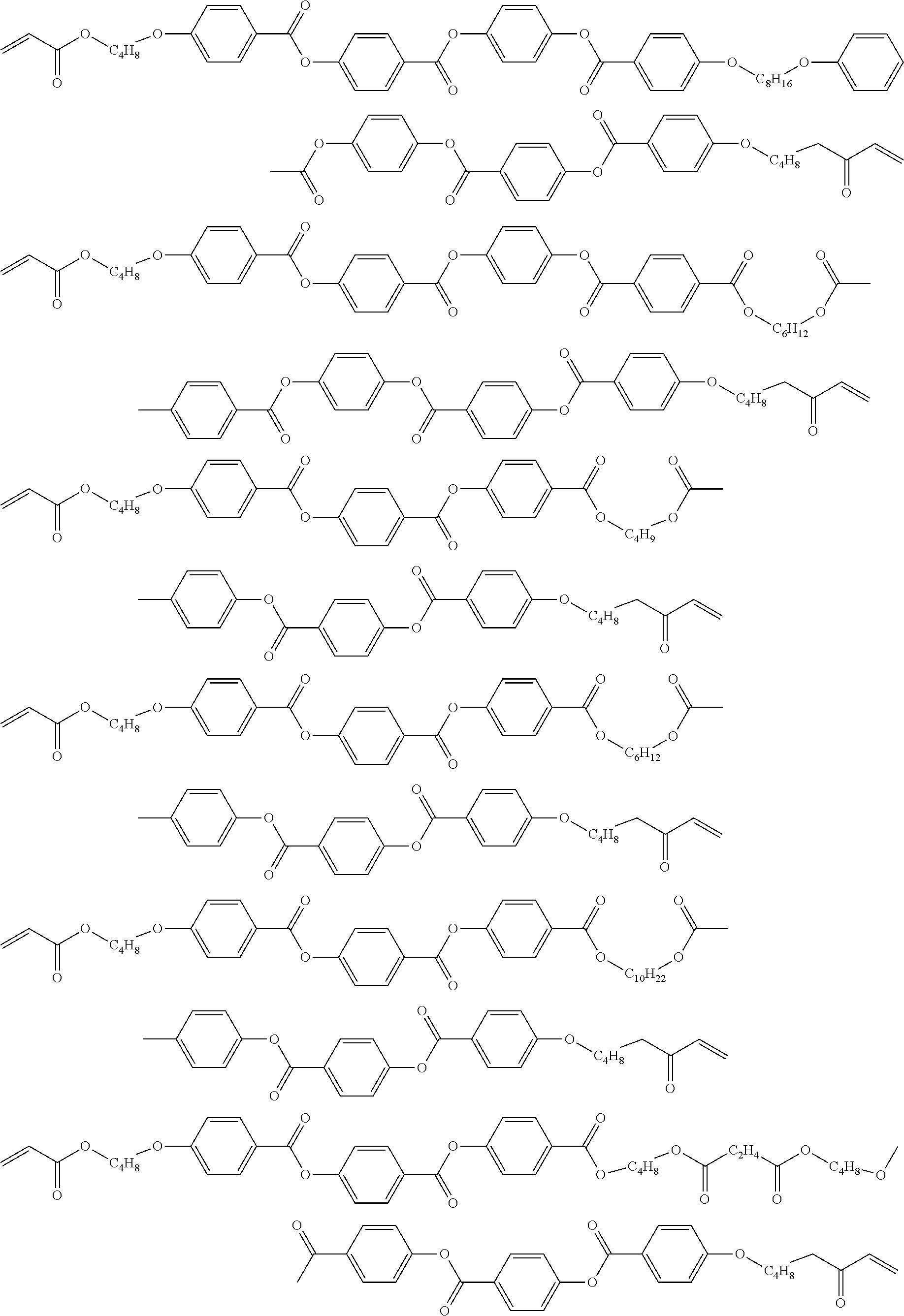

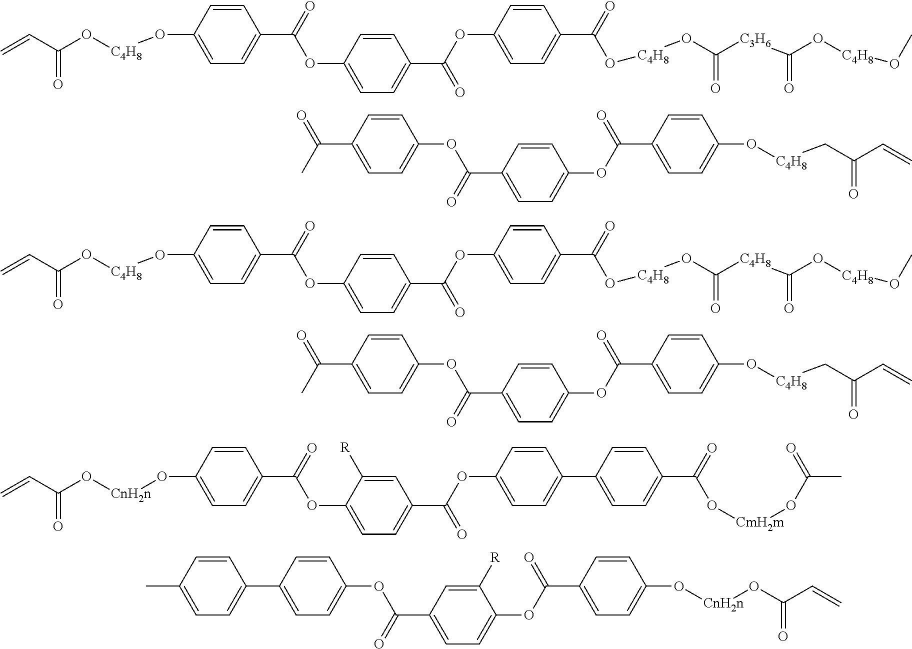

TABLE 1

| n | m | R |
|---|---|---|
| 4 | 4 | H |
| 4 | 6 | H |
| 4 | 10 | H |
| 6 | 10 | H |
| 6 | 12 | H |
| 4 | 8 | OCH3 |
| 4 | 12 | OCH3 |
| 6 | 10 | Br |
| 6 | 12 | Br |
| 8 | 12 | OCH3 |

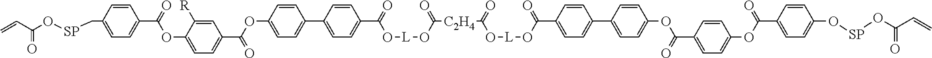

TABLE 2

| SP | L | R |
|---|---|---|
| —(CH2)4— | —(CH2)3— | H |
| —(CH2)4— | —(CH2)3— | Br |
| —(CH2)4— | —(CH2)3— | OCH3 |
| —CH2CH(CH3)CH2— | —(CH2)3— | H |
| —(CH2CH2O)2CH2CH3— | —(CH2)3— | H |
| —(CH2CH2O)2CH2CH3— | —(CH2CH2O)2CH2CH3— | H |

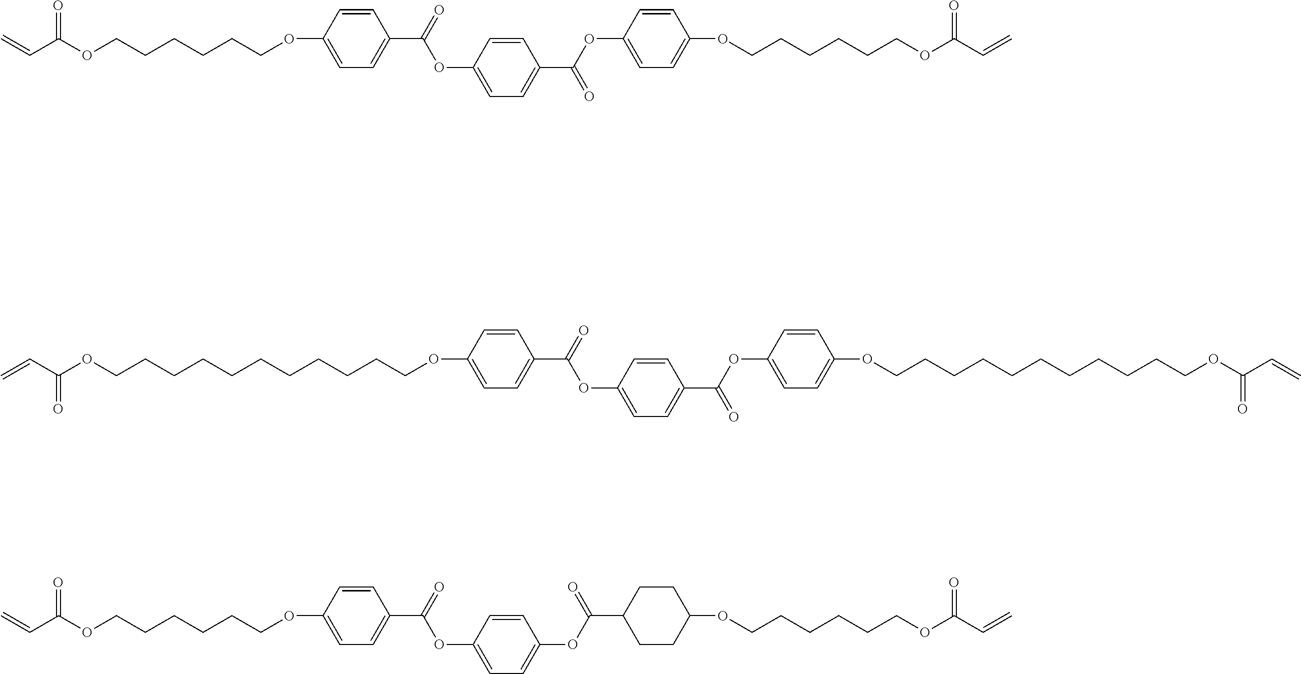

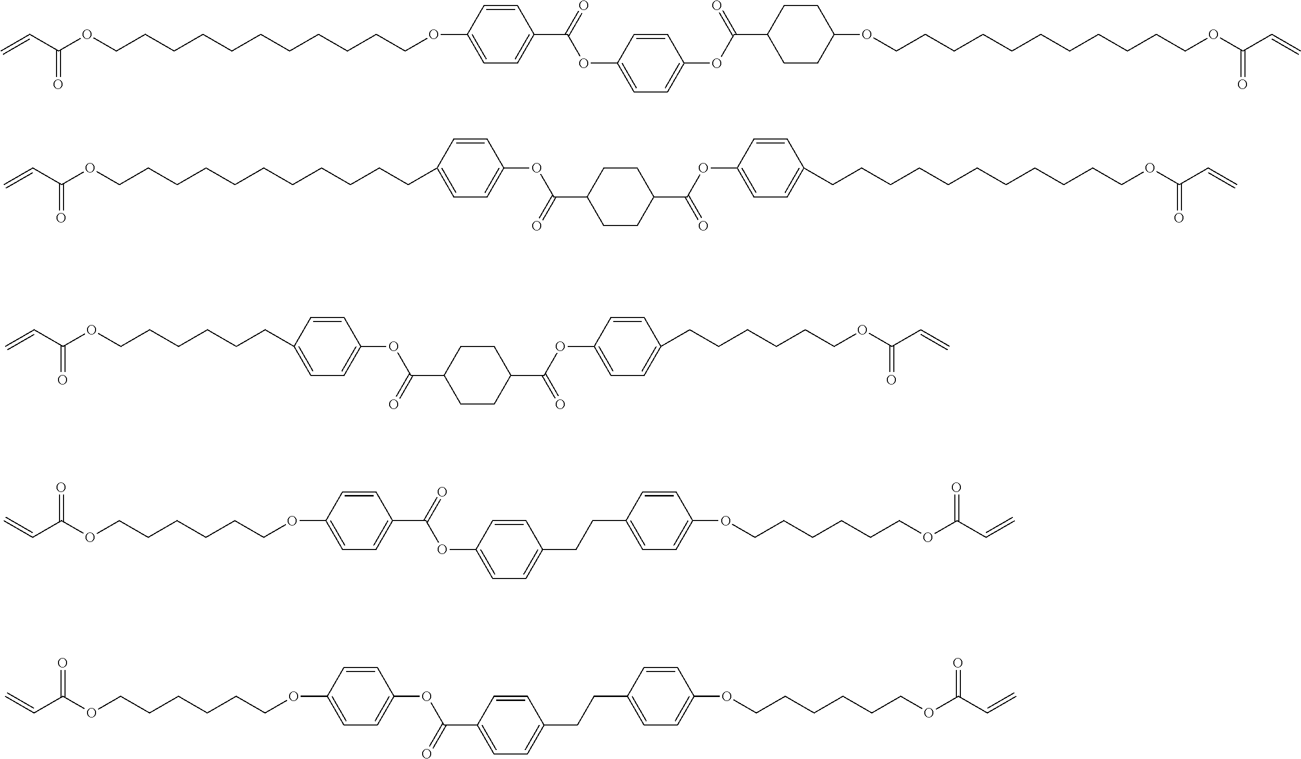

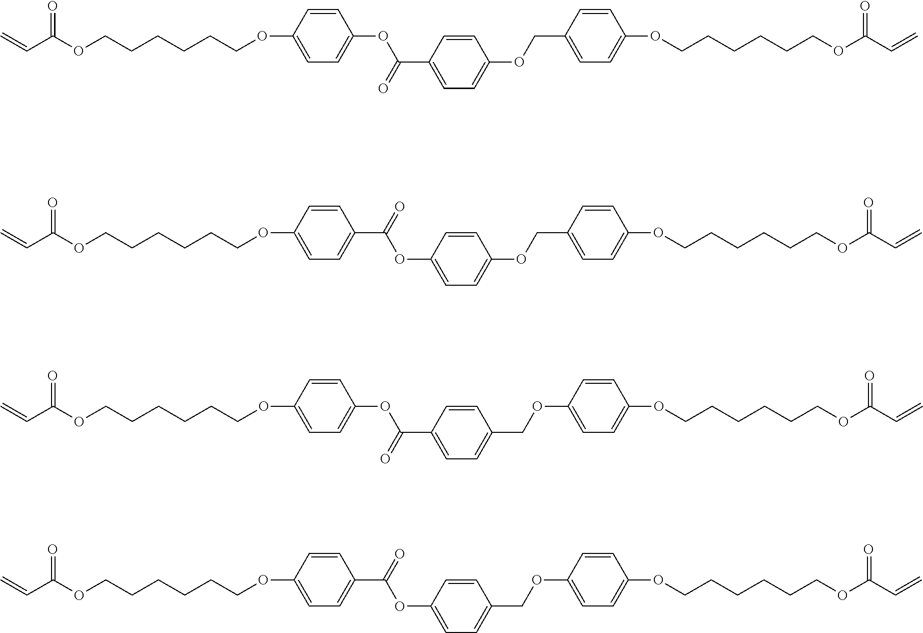

The content of the smectic liquid crystal compound is preferably 50 to 99 mass % and more preferably 60 to 95 mass % with respect to the total solid content mass of the liquid crystal composition forming the anisotropic light absorbing layer.

As a technique of aligning the dichroic colorant in a desired direction, a technique of preparing a polarizer formed of the dichroic colorant or a technique of preparing a guest-host liquid crystal cell can be referred to.

For example, techniques used in a method of preparing a dichroic polarizer, described in JP1999-305036A (JP-H11-305036A) and JP2002-90526A, and a method of preparing a guest-host type liquid crystal display device, described in JP2002-99388A and JP2016-27387A, can be used for preparing the anisotropic light absorbing layer configuring the optical filter used in the optical device according to the embodiment of the present invention.

Specifically, in a case where the technique of the guest-host type liquid crystal cell is used, the anisotropic light absorbing layer according to the embodiment of the present invention can be prepared by mixing a dichroic colorant serving as a guest and a rod-like liquid crystal compound serving as a host liquid crystal, aligning the host liquid crystal, aligning molecules of the dichroic substance along the alignment of the liquid crystal molecules, and immobilizing the alignment state.

In order to prevent fluctuation of light absorbing characteristics of the anisotropic light absorbing layer depending on the use environment, it is preferable that the alignment of the dichroic colorant is immobilized by forming a chemical bond. For example, the alignment can be immobilized by promoting polymerization of the host liquid crystals, the dichroic colorant, and an optionally added polymerizable component.

In the present invention, two or more kinds of dichroic colorants may be used in combination, and it is preferable to use three or more kinds of dichroic colorants in combination.

In a case where two or more dichroic colorants are used in combination, for example, in a case where the contrast further increases for use in a head-mounted display or the like, for the reason that a hue change from an original image can be further suppressed, it is preferable that at least one dichroic colorant having a maximal absorption wavelength in a wavelength range of 370 to 550 nm and at least one dichroic colorant having a maximal absorption wavelength in a wavelength range of 500 to 700 nm are used in combination.

In addition, in a case where three or more kinds of dichroic colorants are used in combination, for the same reason as described above, it is more preferable that at least one dichroic colorant having a maximal absorption wavelength in a wavelength range of 560 nm or more and 700 nm or less, at least one dichroic colorant having a maximal absorption wavelength in a wavelength range of 455 nm or more and less than 560 nm, and at least one dichroic colorant having a maximal absorption wavelength in a wavelength range of 370 nm or more and less than 455 nm are used in combination.

Examples of at least one dichroic colorant having a maximal absorption wavelength in a wavelength range of 560 to 700 nm include a compound represented by Formula (1) described in and after paragraph [0043] of WO2019/189345A. Examples of at least one dichroic colorant having a maximal absorption wavelength in a wavelength range of 455 nm or more and less than 560 nm include a compound represented by Formula (2) described in and after paragraph of WO2019/189345A.

As described above, the content of the dichroic colorant is 5.0 mass % or more with respect to the total solid content mass of the liquid crystal composition forming the anisotropic light absorbing layer. For use in a head-mounted display or the like, for the reason that a hue change from an original image can be further suppressed, the content of the dichroic colorant is preferably 8.0 mass % or more, more preferably 10.0 mass % or more, and still more preferably 10 to 50 mass % with respect to the total solid content mass of the liquid crystal composition. In a case where a plurality of dichroic colorants are used in combination, the total content of the plurality of dichroic colorants is preferably in the above-described range.

Further, the guest-host type liquid crystal cell having a liquid crystal layer that contains at least an dichroic colorant and a host liquid crystal on a pair of substrates may be used as the anisotropic light absorbing layer used in the present invention.

The alignment of the host liquid crystal and the alignment of the organic dichroic colorant molecules in association of the alignment of the host liquid crystal is made such that the alignment state thereof is maintained as long as the alignment can be controlled by the alignment film formed on the inner surface of the substrate and an external stimulus such as an electric field is not applied, and the light absorbing characteristics of the anisotropic light absorbing layer used in the present invention can be set to be constant.

Further, a polymer film that satisfies the light absorbing characteristics required for the anisotropic light absorbing layer used in the present invention can be prepared by allowing the dichroic coloring agent to permeate into the polymer film and aligning the dichroic colorant along the alignment of the polymer molecules in the polymer film. Specifically, the polymer film can be prepared by coating a surface of the polymer film with a solution of an dichroic colorant and allowing the solution to permeate into the film.

The alignment of the dichroic colorant can be adjusted by the alignment of a polymer chain in the polymer film, the properties there of the polymer chain, a coating method, and the like. The properties of the polymer chain refer to chemical and physical properties of the polymer chain or a functional group and the like in the polymer chain. The details of this method are described in JP2002-90526A.

In the present invention, the dichroic colorant (dichroic substance) is defined as a compound having a function of absorbing light.

The dichroic colorant may have any of an absorption maximum or an absorption band and preferably has an absorption maximum in any of a yellow range (Y), a magenta range (M), or a cyan range (C).

In addition, two or more kinds of dichroic colorants may be used, it is preferable that a mixture of dichroic colorants having an absorption maximum in any of Y, M, or C is used, and it is more preferable that dichroic colorants are mixed and used to absorb all the light in a visible range (400 to 750 nm).

Here, the yellow range refers to a wavelength range of 430 to 500 nm, the magenta range refers to a wavelength range of 500 to 600 nm, and the cyan range refers to a wavelength range of 600 to 750 nm.

The thickness of the anisotropic light absorbing layer is preferably 0.1 to 10 μm more preferably 0.3 to 5 μm, and still more preferably 0.5 to 3 μm.

By adjusting the thickness of the anisotropic light absorbing layer to be 0.1 μm or more, diffracted light caused by oblique incidence can be sufficiently shielded. By adjusting the thickness of the anisotropic light absorbing layer to be 10 μm or less, the transmittance of external light of the front side (front external light I₀) is sufficient, and the visibility of the background can be suitably ensured.

### -Method of Manufacturing Anisotropic Light Absorbing Layer-

A method of manufacturing the anisotropic light absorbing layer is not particularly limited as long as a major axis of the dichroic colorant can be aligned to a direction perpendicular to a substrate surface (horizontal surface), and can be appropriately selected according to the purpose. Examples of the method of manufacturing the anisotropic light absorbing layer include (1) a guest-host liquid crystal method, (2) an anodized alumina method, (3) surface energy control of a substrate, (4) use of a surfactant.

In (1) the guest-host liquid crystal method, an absorbing layer coating liquid including at least an ultraviolet-curable liquid crystal compound and a dichroic colorant is applied to a substrate including an alignment film on a surface, is dried to form a coating layer, and the coating layer is irradiated with ultraviolet light in a state of being heated to a temperature at which a liquid crystal phase is exhibited. As a result, an anisotropic light absorbing layer where a major axis of the dichroic colorant is aligned to a direction substantially perpendicular to a substrate surface is formed.

### <Polarizer>

As described above, in a preferable aspect, the optical filter forming the optical device according to the embodiment of the present invention includes a polarizer in addition to the anisotropic light absorbing layer. The polarizer used in the present invention is a polarizer where an absorption axis is present in a main surface. That is, the polarizer is a polarizer where an absorption axis is parallel to a main surface.

By including the polarizer, as described above, the optical filter acts as a polarizer disposed in a crossed nicols state on the oblique external light I_{S} such that the oblique external light I_{S} can be suitably shielded (absorbed).

Various well-known polarizers where an absorption axis is parallel to a main surface can be used. Examples of the polarizer include an iodine-based polarizer obtained by impregnating a PVA stretched film with polyiodide ions, a dye-based polarizer obtained by impregnating a PVA stretched film with a dichroic colorant, and an anisotropic light absorbing layer having an optical performance where the absorption axis of the above-described anisotropic light absorbing layer is aligned to be parallel to the main surface.

### <Retardation Layer>

In the optical device according to the embodiment of the present invention, the optical filter may include a retardation layer between the anisotropic light absorbing layer and the polarizer in addition to the anisotropic light absorbing layer and the polarizer. That is, the optical filter may be a laminate including the polarizer where the absorption axis is parallel to the main surface, the retardation layer, the anisotropic light absorbing layer where the angle of the absorption axis is 0° to 45° with respect to the normal line of the main surface.

By including the retardation layer, the optical filter can adjusts the polarization direction of the oblique external light I_{S} to more suitably shield the oblique external light I_{S}. As a result, by including the retardation layer, the optical filter can suppress rainbow unevenness caused by the external light incident from the oblique upper side of the head (the front side in the upper oblique direction of the head).

As the retardation layer, for example, a B-plate is suitably used.

The B-plate refers to a biaxial optical member in which the refractive indices nx, ny, and nz are values different from each other.

Here, the refractive index nx represents an refractive index in a film in-plane slow axis direction (a direction in which the refractive index is the maximum in a plane), the refractive index ny represents an refractive index in a direction orthogonal to the in-plane slow axis in a plane, and the refractive index nz represents a refractive index in a thickness direction.

Re (in-plane retardation) of the B-plate is more than 80 nm and less than 250 nm, more preferably 100 nm or more and less than 250 nm, and still more preferably 100 nm or more and 200 nm or less.

In addition, an Nz coefficient of the B-plate is preferably more than 1.5, more preferably 2.0 or more and 10. 0 or less, and still more preferably 3.0 or more and 5.0 or less.

It is preferable that Rth of the B-plate is set such that both Re and the Nz coefficient are in the above-described preferable ranges. Specifically, Rth is preferably more than 60 nm.

In addition, in a case where the direction of the absorption axis of the polarizer is set as 0°, an azimuthal angle (angle with respect to the absorption axis of the polarizer) of the slow axis of the B-plate is preferably −10° or more and 10° or less, more preferably −5° or more and 5° or less, and most preferably 0° (that is, parallel to the polarizer absorption axis). That is, the angle between the slow axis of the B-plate and the absorption axis of the polarizer is preferably 10° or less, more preferably 5° or less, and most preferably 0°.

In a case where the optical characteristics of the B-plate are in the above-described ranges, in a view in a direction oblique to the polarizer absorption axis in a film plane instead of a direction parallel or perpendicular thereto, deviations from the polarizer absorption axis and the vertical direction of the absorption axis can be compensated for, and the transmittance in the direction can be reduced.

In the optical filter according to the embodiment of the present invention, as the retardation layer, for example, a combination of a positive A-plate and a positive C-plate can also be suitably used. That is, as the retardation layer, a laminate where a positive A-plate and a positive C-plate are laminated can also be suitably used.

Here, the positive A-plate refers to an optical member where refractive indices nx, ny, and nz satisfy Expression (1).

$$nx > ny \approx nz \qquad Expression ( 1 )$$

In addition, the positive C-plate refers to an optical member where refractive indices nx, ny, and nz satisfy Expression (2).

$$nz > nx \approx ny \qquad Expression ( 2 )$$

Re of the laminate including the positive C-plate and the positive A-plate is preferably more than 80 nm and less than 250 nm, more preferably 100 to 200 nm, and still more preferably 100 to 150 nm. Since the positive C-plate satisfies Re≈0, Re of the laminate including the positive C-plate and the positive A-plate is the same as Re of the positive A-plate, and the slow axis of the laminate including the positive C-plate and the positive A-plate is substantially the same as the slow axis of the positive A-plate.

In addition, the azimuthal angle of the slow axis of the positive A-plate is preferably 80° to 100°, more preferably 85° to 95°, and still more preferably 90° (that is, perpendicular to the polarizer absorption axis). That is, an angle between the slow axis of the positive A-plate and the absorption axis of the polarizer is preferably 80° to 100°, more preferably 85° to 95°, and still more preferably 90°.

Rth of the laminate between the positive C-plate and the positive A-plate is preferably less than −60 nm, more preferably −600 to 100 nm, and still more preferably −500 nm to −200 nm. Since the positive A-Plate satisfies Rth≈Re/2, Rth of the laminate including the positive C-plate and the positive A-plate is the sum of Rth of the positive A-plate and Rth of the positive C-plate.

In a case where the optical characteristics of the positive C-plate and the positive A-plate are in the above-described ranges, in a view in a direction oblique to the polarizer absorption axis in a film plane instead of a direction parallel or perpendicular thereto, deviations from the polarizer absorption axis and the vertical direction of the polarizer absorption axis can be compensated for, and the transmittance in the direction can be reduced.

In addition, it is preferable that wavelength dispersion of Re and Rth of the positive C-plate and the positive A-plate is reverse dispersion in order to reduce coloration of light transmitted through the optical filter according to the embodiment of the present invention.

More specifically, in a case where the optical filter of the optical element according to the embodiment of the present invention includes the retardation layer, it is preferable that wavelength dependence of the retardation layer satisfies Re(450 nm)<Re(550 nm)<Re(650 nm) or Rth(450 nm)<Rth(550 nm)<Rth(650 nm).

In the optical device according to the embodiment of the present invention, in a case where the laminate including the positive C-plate and the positive A-plate is used as the retardation layer of the optical filter, it is preferable that the positive A-plate is provided on an anisotropic light absorbing layer side. That is, in a case where the laminate including the positive C-plate and the positive A-plate is used as the retardation layer, it is preferable that the optical filter is a laminate where the polarizer, the positive C-plate, the positive A-plate, and the anisotropic light absorbing layer are laminated in this order.

This configuration is preferable from the viewpoint that the oblique external light I_{S} can be more suitably shielded by the optical filter.

In the optical device according to the embodiment of the present invention, a configuration where the optical filter includes a retardation layer having a twisted structure between two anisotropic light absorbing layers can also be suitably used. That is, the optical filter may be a laminate including the anisotropic light absorbing layer where the angle of the absorption axis is 0° to 45° with respect to the normal line of the main surface, the retardation layer having the twisted structure, and the anisotropic light absorbing layer where the angle of the absorption axis is 0° to 45° with respect to the normal line of the main surface in this order.

In the present specification, Δn·d represents the retardation of the retardation layer having the twisted structure, and is represented by the product of a thickness d of a liquid crystal layer and a birefringence index Δn of liquid crystal. Further, a twisted angle represents the angle at which a liquid crystal director of a refractive index anisotropic layer rotates on upper and lower surfaces of a substrate.

In addition, it is preferable that the retardation layer having the twisted structure satisfies the following Expression because the effect of the present invention that rainbow unevenness is suitably suppressed can be obtained.

Expression (3): 200 nm≤Δn·d≤1500 nm

Expression (4): 135·(2n−1)≥twisted angle (°)≥45·(2n−1)

In Expression (4), n represents a natural number. Unless otherwise specified, Δn represents a value at a wavelength of 550 nm.

The retardation layer having the twisted structure includes a liquid crystal layer formed of a rod-like or disk-like liquid crystal compound or a TN liquid crystal cell, a STN liquid crystal cell, or a VATN liquid crystal cell where the alignment state can be controlled by voltage application. By using the liquid crystal cell where the alignment state can be controlled by voltage application, the retardation layer can switch between a light shielding state and a transmission state.

In the optical device according to the embodiment of the present invention, the optical filter optionally include, in addition to the anisotropic light absorbing layer, the polarizer, and the retardation layer, a protective layer, an oxygen blocking layer, a bonding layer such as a pressure-sensitive adhesive layer or an adhesive layer, an ultraviolet absorbing layer, and a layer such as a blue light absorbing layer that absorbs specific visible light.

The optical filter configuring the optical device according to the embodiment of the present invention can also be used for various optical devices other than the above-described head-mounted display.

For example, by disposing the optical filter on the entire surface of an image display apparatus such as a liquid crystal display or an organic EL display, a function of preventing peeping from the surroundings can be exhibited. In addition, by disposing the optical filter on the entire surface of the image display apparatus, penetration of external light such as illumination light or sunlight can be significantly reduced, and bright room contrast can be improved.

### EXAMPLES

Hereinafter, the present invention will be described in detail using examples. The materials, the reagents, the amounts of substances and the proportions of the substances, the operations, and the like shown in the following examples can be appropriately changed within a range not departing from the scope of the present invention. Therefore, the scope of the present invention is not limited to the following specific examples.

### Preparation of Laminate V including Anisotropic Light Absorbing Layer V

### [Formation of Alignment Film AL1]

A surface of a commercially available cellulose acylate film (manufactured by FUJIFILM Corporation, trade name: FUJITAC TG40UL) was saponified with an alkaline solution, and the following composition 1 for forming an alignment film was applied thereto using a wire bar. The support on which the coating film was formed was dried with hot air at 60° C. for 60 seconds, and was further dried with hot air at 100° C. for 120 seconds to form an alignment film AL1, thereby obtaining a TAC film 1 with the alignment film. The film thickness of the alignment film AL1 was 1 μm.

(Composition 1 for Forming Alignment Film)

| | | |
|---|---|---|
| Modified polyvinyl alcohol PVA-1 shown below | 3.80 | parts by mass |
| IRGACURE 2959 | 0.20 | parts by mass |
| Water | 70 | parts by mass |
| Methanol | 30 | parts by mass |

### Modified Polyvinyl Alcohol PVA-1

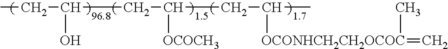

### [Formation of Anisotropic Light Absorbing Layer V)

The following composition P1 for forming an anisotropic light absorbing layer was continuously applied to the obtained TAC film 1 with the alignment film using a wire bar, was heated at 120° C. for 60 seconds, and was cooled to room temperature (23° C.).

Next, the coating layer was heated at 120° C. for 60 seconds, and was cooled to room temperature again.

Next, the coating layer was irradiated with light using a LED lamp (central wavelength: 365 nm) from a film normal direction for 2 seconds under an irradiation condition of an illuminance of 200 mW/cm² to prepare an anisotropic light absorbing layer V on the alignment film AL1. The film thickness of the anisotropic light absorbing layer V was 3.5 μm.

(Composition P1 for Forming Anisotropic Light Absorbing Layer)

| | | |
|---|---|---|
| Dichroic colorant D-1 shown below | 0.63 | parts by mass |
| Dichroic colorant D-2 shown below | 0.17 | parts by mass |
| Dichroic colorant D-3 shown below | 1.13 | parts by mass |
| Polymer liquid crystal compound | 8.18 | parts by mass |
| P-1 shown below | | |
| IRGACURE OXE-02 (manufactured | 0.16 | parts by mass |
| by BASF SE) | | |
| Alignment agent E-1 shown below | 0.13 | parts by mass |
| Alignment agent E-2 shown below | 0.13 | parts by mass |
| Surfactant F-1 shown below | 0.004 | parts by mass |
| Cyclopentanone | 85.01 | parts by mass |
| Benzyl alcohol | 4.47 | parts by mass |

### Dichroic Colorant D-1

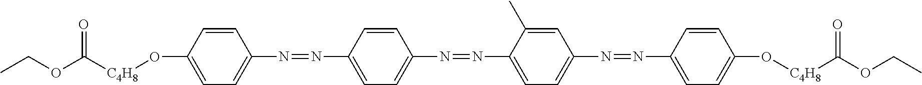

### Dichroic Colorant D-2

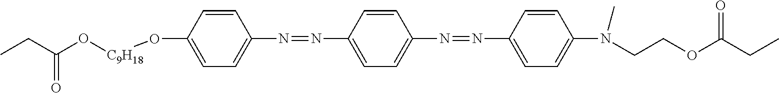

### Dichroic Colorant D-3

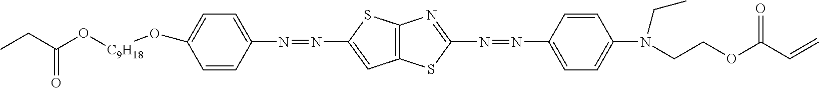

### Polymer Liquid Crystal Compound P-1

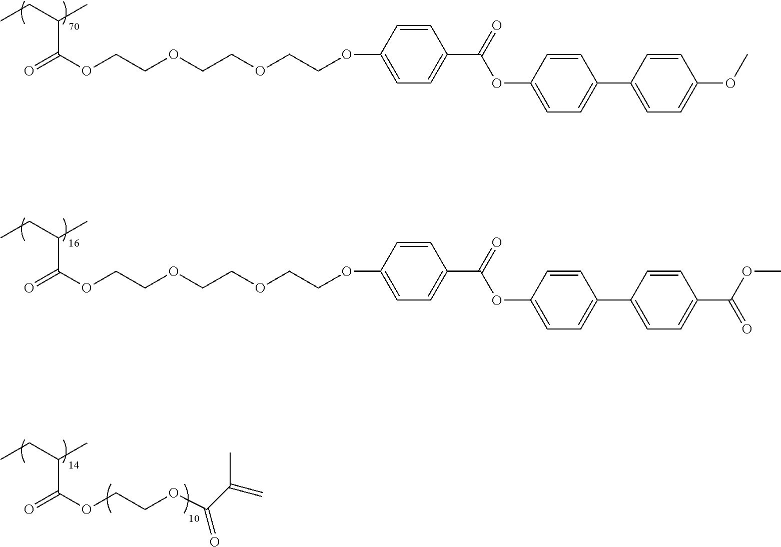

### Alignment Agent E-1

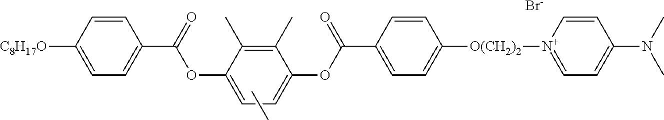

### Alignment Agent E-2

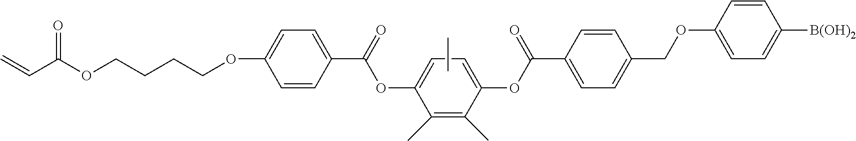

### Surfactant F-1

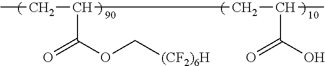

### [Formation of Protective Layer B1]

The following composition B1 for forming a protective layer was continuously applied to the obtained anisotropic light absorbing layer V using a wire bar to form a coating film.

Next, the support on which the coating film was formed was dried with hot air at 60° C. for 60 seconds, and was further dried with hot air at 100° C. for 120 seconds to form a protective layer B1, thereby preparing a laminate V. The film thickness of the protective layer was 0.5 μm.

In a case where a transmittance central axis angle θ of the prepared laminate V was measured using the above-described method, the transmittance central axis angle θ was 0°. Since none of the layer configurations of the laminate V other than the anisotropic light absorbing layer V had light-absorbing anisotropy, the transmittance central axis angle θ calculated as described above can be read as the value of the anisotropic light absorbing layer V in the laminate V.

In addition, using AxoScan OPMF-1 (manufactured by Opto Science, Inc.), a transmittance of the laminate at a wavelength of 550 nm was measured. The transmittance of the laminate in the normal direction was 78%, and the transmittance in a direction tilted by 30° from the normal direction of the laminate was 17%.

(Composition B1 for Forming Protective Layer)

| | |
|---|---|
| • Modified polyvinyl alcohol PVA-1 shown above | 3.88 parts by mass |

| | |
|---|---|
| • IRGACURE 2959 | 0.20 parts by mass |
| • Water | 70 parts by mass |
| • Methanol | 30 parts by mass |

### Preparation of Laminate V2 including Anisotropic Light Absorbing Layer V2

### [Formation of Alignment Film AL2]

The following composition 2 for forming an alignment film was applied to a surface of a commercially available cellulose acylate film (manufactured by FUJIFILM Corporation, trade name: FUJITAC TG40UL) using a wire bar. The support on which the coating film was formed was dried with hot air at 140° C. for 120 seconds to form an alignment film AL2, thereby obtaining a TAC film 2 with the alignment film. The film thickness of the alignment film AL2 was 1 μm.

(Composition 2 for Forming Alignment Film)

| | |
|---|---|
| • Polymer PA-1 shown below | 100.00 parts by mass |
| • Acid generator PAG-1 shown below | 8.25 parts by mass |
| • Stabilizer DIPEA shown below | 0.6 parts by mass |

| | |
|---|---|
| • Butyl acetate | 1001.42 parts by mass |
| • Methyl ethyl ketone | 250.36 parts by mass |

Polymer PA-1 (in the formula, the numerical value described in each of repeating unit represents the content (mass %) of each of the repeating units with respect to all the repeating units)

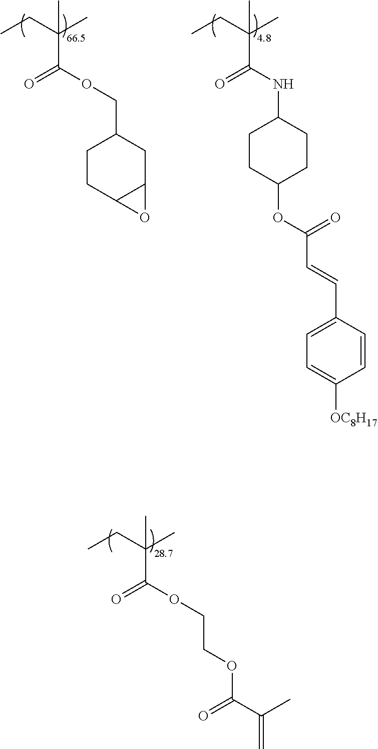

### Acid Generator PAG-1

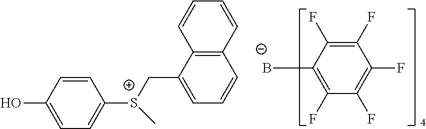

### Stabilizer DIPEA

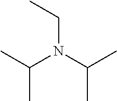

### [Formation of Anisotropic Light Absorbing Layer V2)

The following composition P2 for forming an anisotropic light absorbing layer was continuously applied to the obtained TAC film 2 with the alignment film using a wire bar, was heated at 120° C. for 60 seconds, and was cooled to room temperature (23° C.).

Next, the coating layer was heated at 85° C. for 60 seconds, and was cooled to room temperature again.

Next, the coating layer was irradiated with light using a LED lamp (central wavelength: 365 nm) from a film normal direction for 2 seconds under an irradiation condition of an illuminance of 200 mW/cm² to prepare an anisotropic light absorbing layer V2 on the alignment film AL2. The film thickness of the anisotropic light absorbing layer V2 was 4.5 μm.

(Composition P2 for Forming Anisotropic Light Absorbing Layer)

| | |
|---|---|
| • Dichroic colorant D-1 shown above | 0.69 parts by mass |
| • Dichroic colorant D-2 shown above | 0.17 parts by mass |
| • Dichroic colorant D-4 shown below | 1.13 parts by mass |
| • Polymer liquid crystal compound P-1 shown above | 8.67 parts by mass |
| • Liquid crystal compound L-2 shown below | 1.97 parts by mass |
| • IRGACURE OXE-02 (manufactured by BASF SE) | 0.20 parts by mass |
| • Alignment agent E-1 shown above | 0.16 parts by mass |
| • Alignment agent E-2 shown above | 0.16 parts by mass |

| | |
|---|---|
| • Surfactant F-2 shown below | 0.007 parts by mass |
| • Cyclopentanone | 78.17 parts by mass |
| • Benzyl alcohol | 8.69 parts by mass |

### Dichroic Colorant D-4

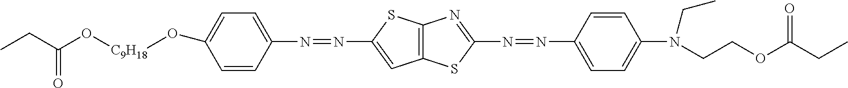

### Liquid Crystalline Compound L-2 [Mixture of the Following Liquid Crystal Compounds (RA), (RB), and (RC) at a Ratio of 84:14:2 (Mass Ratio)]

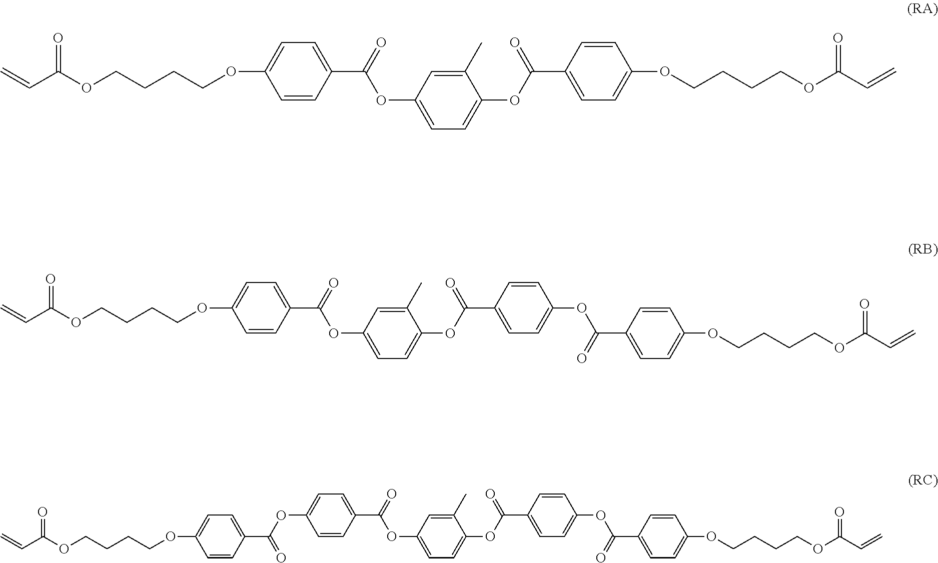

### Surfactant F-2

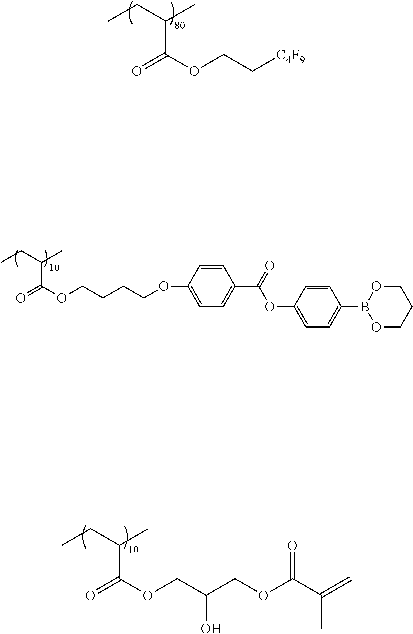

### [Formation of Protective Layer B2]

The following composition B2 for forming a protective layer was continuously applied to the obtained anisotropic light absorbing layer V2 using a wire bar to form a coating film.

Next, the support on which the coating film was formed was dried with hot air at 60° C. for 60 seconds, and was further dried with hot air at 100° C. for 120 seconds to form a protective layer B2, thereby preparing a laminate V2. The film thickness of the protective layer was 0.5 μm.

In a case where a transmittance central axis angle θ of the prepared laminate V2 was measured using the above-described method, the transmittance central axis angle θ was 0°. Since none of the layer configurations of the laminate V2 other than the anisotropic light absorbing layer V2 had light-absorbing anisotropy, the transmittance central axis angle θ calculated as described above can be read as the value of the anisotropic light absorbing layer V2 in the laminate V2.

In addition, using AxoScan OPMF-1 (manufactured by Opto Science, Inc.), a transmittance of the laminate at a wavelength of 550 nm was measured. The transmittance of the laminate in the normal direction was 78%, and the transmittance in a direction tilted by 30° from the normal direction of the laminate was 17%.

(Composition B2 for Forming Protective Layer)

| | |
|---|---|
| • Modified polyvinyl alcohol PVA-1 shown above | 3.80 parts by mass |

| | |
|---|---|
| • IRGACURE 2959 | 0.20 parts by mass |

• Coloring agent compound G-1 shown below: 0.08 parts by mass

| | |
|---|---|
| • Water | 70 parts by mass |
| • Methanol | 30 parts by mass |

### Coloring Agent Compound G-1

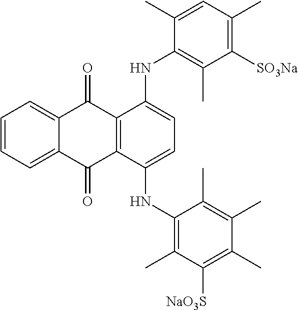

### Preparation of Laminate V3 Including Anisotropic Light Absorbing Layer V3

A laminate V3 was prepared using the same method as that of the laminate V1, except that a composition P3 for forming an anisotropic light absorbing layer having the following composition was used instead of the composition P1 for forming an anisotropic light absorbing layer.

In a case where a transmittance central axis angle θ of the prepared laminate V3 was measured using the above-described method, the transmittance central axis angle θ was 0°. Since none of the layer configurations of the laminate V3 other than the anisotropic light absorbing layer V3 had light-absorbing anisotropy, the transmittance central axis angle θ calculated as described above can be read as the value of the anisotropic light absorbing layer V3 in the laminate V3.

In addition, using AxoScan OPMF-1 (manufactured by Opto Science, Inc.), a transmittance of the laminate at a wavelength of 550 nm was measured. The transmittance of the laminate in the normal direction was 69%, and the transmittance in a direction tilted by 30° from the normal direction of the laminate was 15%.

(Composition P3 for Forming Anisotropic Light Absorbing Layer)

| | |
|---|---|
| • Dichroic substance D-5 shown below | 1.82 parts by mass |
| • Dichroic substance D-6 shown below | 0.49 parts by mass |
| • Dichroic substance D-7 shown below | 3.25 parts by mass |
| • Polymer liquid crystal compound P-1 shown above | 18.21 parts by mass |
| • Liquid crystal compound L-2 shown above | 4.13 parts by mass |
| • IRGACURE 369 (manufactured by BASF SE) | 1.67 parts by mass |
| • Alignment agent E-1 shown above | 0.37 parts by mass |
| • Alignment agent E-2 shown above | 0.37 parts by mass |
| • BYK-361N (manufactured by BYK-Chemie GmbH) | 0.084 parts by mass |

| | |
|---|---|
| • o-xylene | 69.60 parts by mass |

### Dichroic Substance D-5

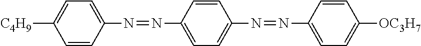

### Dichroic Substance D-6

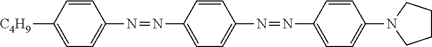

### Dichroic Substance D-7

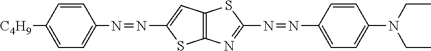

### Preparation of Laminate V4 including Anisotropic Light Absorbing Layer V4

A laminate V4 was prepared using the same method as that of the laminate V1, except that a composition P4 for forming an anisotropic light absorbing layer having the following composition was used instead of the composition P1 for forming an anisotropic light absorbing layer.

In a case where a transmittance central axis angle θ of the prepared laminate V4 was measured using the above-described method, the transmittance central axis angle θ was 0°. Since none of the layer configurations of the laminate V4 other than the anisotropic light absorbing layer V4 had light-absorbing anisotropy, the transmittance central axis angle θ calculated as described above can be read as the value of the anisotropic light absorbing layer V4 in the laminate V4.

In addition, using AxoScan OPMF-1 (manufactured by Opto Science, Inc.), a transmittance of the laminate at a wavelength of 550 nm was measured. The transmittance of the laminate in the normal direction was 70%, and the transmittance in a direction tilted by 30° from the normal direction of the laminate was 15%.

(Composition P4 or Forming Anisotropic Light Absorbing Layer)

| | |
|---|---|
| • Dichroic substance D-1 shown above | 0.79 parts by mass |
| • Dichroic substance D-2 shown above | 0.21 parts by mass |
| • Dichroic substance D-4 shown above | 1.41 parts by mass |
| • Liquid crystal compound L-3 shown below | 7.52 parts by mass |
| • Liquid crystal compound L-4 shown below | 2.51 parts by mass |
| • IRGACURE 369 (manufactured by BASF SE) | 0.73 parts by mass |
| • BYK-361N (manufactured by BYK-Chemie GmbH) | 0.036 parts by mass |

| | |
|---|---|
| • Cyclopentanone | 78.13 parts by mass |
| • Benzyl alcohol | 8.67 parts by mass |

### Liquid Crystal Compound L-3

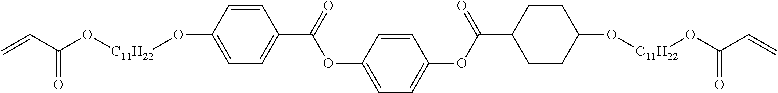

### Liquid Crystal Compound L-4

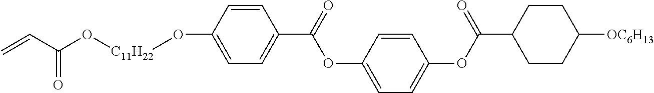

### Preparation of Laminate V5 including Anisotropic Light Absorbing Layer V5

A laminate V5 was prepared using the same method as that of the laminate V1, except that a composition P5 for forming an anisotropic light absorbing layer having the following composition was used instead of the composition P1 for forming an anisotropic light absorbing layer.

In a case where a transmittance central axis angle θ of the prepared laminate V5 was measured using the above-described method, the transmittance central axis angle θ was 0°. Since none of the layer configurations of the laminate V5 other than the anisotropic light absorbing layer V5 had light-absorbing anisotropy, the transmittance central axis angle θ calculated as described above can be read as the value of the anisotropic light absorbing layer V5 in the laminate V5.

In addition, using AxoScan OPMF-1 (manufactured by Opto Science, Inc.), a transmittance of the laminate at a wavelength of 550 nm was measured. The transmittance of the laminate in the normal direction was 65%, and the transmittance in a direction tilted by 30° from the normal direction of the laminate was 12%.

(Composition P5 for Forming Anisotropic Light Absorbing Layer)

| | |
|---|---|
| • Dichroic substance D-5 shown above | 0.78 parts by mass |
| • Dichroic substance D-6 shown above | 0.21 parts by mass |
| • Dichroic substance D-7 shown above | 1.39 parts by mass |
| • Liquid crystal compound L-3 shown above | 7.39 parts by mass |
| • Liquid crystal compound L-4 shown above | 2.46 parts by mass |
| • IRGACURE 369 (manufactured by BASF SE) | 0.71 parts by mass |
| • BYK-361N (manufactured by BYK-Chemie GmbH) | 0.036 parts by mass |

| | |
|---|---|
| • o-xylene | 87.02 parts by mass |

### [Preparation of PVA Polarizing Plate]

A PVA film having a film thickness of 30 an average degree of polymerization of 2400, and a degree of saponification of 99.9 mol % was dipped in warm water at 25° C. for 120 seconds to swell the film. Next, the PVA film was dyed while being dipped in an aqueous solution having a concentration of 0.6 wt % of iodine/potassium iodide (weight ratio=2/3) and stretched to 2.1 times. Next, the film was stretched in a boric acid ester aqueous solution at 55° C. such that the total stretching ratio reached 5.5 times, was washed with water, and was dried to prepare a PVA polarizer. The thickness of the PVA polarizer was 8 μm.

The saponified cellulose acylate film (TAC substrate having a thickness of 40 μm; manufactured by FUJIFILM Corporation, TG40UL) was laminated on both surfaces of the PVA polarizer using a completely saponified polyvinyl alcohol 5% aqueous solution as an adhesive. Next, the polarizer on which the cellulose acylate films were laminated was passed through a nip roll machine, and then was dried at 60° C. for 10 minutes to obtain a PVA polarizing plate.

### [Preparation of B-Plate]

A cycloolefin resin (manufactured by JSR Corporation, ARTON G7810) was dried at 100° C. for 2 hours or longer, and melt-extruded at 280° C. using a twin screw kneading extruder. Here, a screen filter, a gear pump, and a leaf disk filter were arranged in this order between the extruder and a die, these were connected by a melt pipe, and the resultant was extruded from a T-die having a width of 1000 mm and a lip gap of 1 mm and was cast on a triple cast roll in which temperatures were set to 180° C., 175° C., and 170° C., thereby obtaining an non-stretched film 1 having a width of 900 mm and a thickness of 320 μm.

A stretching process and a thermal fixation process were performed using the following method on the non-stretched film 1 that was being transported.

(a) Machine-Direction Stretching The non-stretched film 1 was stretched in the machine direction under the following conditions while being transported using an inter-roll machine-direction stretching machine having an aspect ratio (L/W) of 0.2.

Preheating temperature: 170° C., stretching temperature: 170° C., and stretching ratio: 155%

### (b) Cross-Direction Stretching

The film that was stretched in the machine direction was stretched in the cross-direction under the following conditions while being transported using a tenter.

Preheating temperature: 170° C., stretching temperature: 170° C., stretching ratio: 80%

After the stretching process, a heat treatment was performed on the stretched film under the following conditions while end portions of the stretched film were gripped with a tenter clip to hold both end portions of the stretched film such that the width thereof was constant (within 3% of expansion or contraction), and the stretched film was thermally fixed.

Thermal fixation temperature: 165° C., thermal fixation time: 30 seconds

The preheating temperature, the stretching temperature, and the thermal fixation temperature are average values of values measured at five points in the width direction using a radiation thermometer.

After the thermal fixation, both ends of the stretched film were trimmed and wound at a tension of 25 kg/m, thereby obtaining a film roll having a width of 1340 mm and a winding length of 2000 m. The obtained stretched film had an in-plane retardation Re of 160 nm at a wavelength of 550 nm, a thickness-direction retardation Rth of 390 nm at a wavelength of 550 nm, an Nz coefficient of 2.9, a slow axis in the MD direction, and a film thickness of 80 μm. The obtained film was set as a B-plate.

### Preparation of Laminate including Positive A-plate and Positive C-plate

### (Preparation of Photo-Alignment Film)

A coating liquid 1 for forming a photo-alignment film was prepared with reference to the description of Example 3 in JP2012-155308A.

The coating liquid 1 for forming a photo-alignment film prepared in advance was applied to one surface of a cellulose acetate film (manufactured by FUJIFILM Corporation, mZ-TAC) using a bar coater. After the application, the coating film was dried on a hot plate at 120° C. for 2 minutes to remove the solvent, thereby forming a coating film. The obtained coating film was irradiated with polarized ultraviolet light (10 mJ/cm², using an ultra-high pressure mercury lamp) to form a photo-alignment film AL2.

(Formation of Positive A-Plate Layer Including Horizontally Aligned Rod-Like Liquid Crystal Compound having Reverse Wavelength Dispersibility)

A composition 1 for forming a liquid crystal layer having the following composition was prepared.

The composition 1 for forming a liquid crystal layer was applied to the photo-alignment film AL2 using a bar coater to form a composition layer. The formed composition layer was heated to 110° C. on a hot plate, and was cooled to 60° C. to stabilize the alignment. Then, the temperature was kept at 60° C., and the alignment was immobilized by ultraviolet irradiation (500 mJ/cm², using an ultra-high pressure mercury lamp) in a nitrogen atmosphere (oxygen concentration: 100 ppm) to prepare a retardation layer having a thickness of 1.5 μm. The obtained retardation layer was a positive A-plate, Re(550)=120 nm, and Re(450)/Re(550)=0.86.

(Composition 1 for Forming Liquid Crystal Layer)

| | |
|---|---|
| • Liquid crystal compound R2 | 42.00 parts by mass |
| • Liquid crystal compound R3 | 42.00 parts by mass |
| • Polymerizable compound B2 | 16.00 parts by mass |
| • Polymerization initiator P3 | 0.50 parts by mass |

| | |
|---|---|
| • Surfactant S3 | 0.15 parts by mass |

• Hisolve MTEM (manufactured by TOHO Chemical Industry Co., Ltd.)
2.00 parts by mass

| | |
|---|---|
| • NK ESTER A-200 (manufactured by Shin Nakamura Chemical Co., Ltd.) | 1.00 |

part by mass

| | |
|---|---|
| • Methyl ethyl ketone | 424.8 parts by mass |

### Liquid Crystal Compound R2

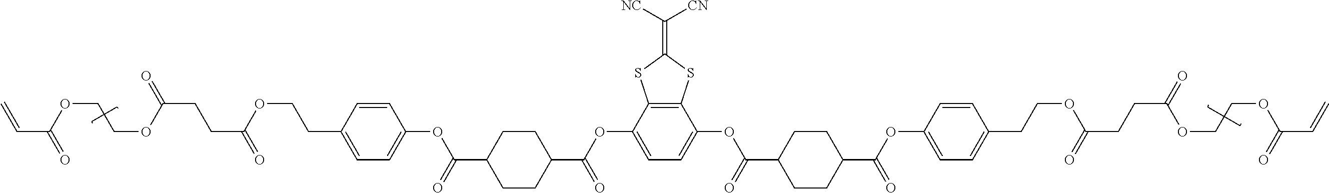 [SMILES: C=CC(=O)OCCOC(=O)CCC(=O)OCCc1ccc(OC(=O)C2CCC(C(=O)Oc3ccc(OC(=O)C4CCC(C(=O)Oc5ccc(CCOC(=O)CCC(=O)OCCOC(=O)C=C)cc5)CC4)c4c3SC(=C(C#N)C#N)S4)CC2)cc1]

### Liquid Crystal Compound R3

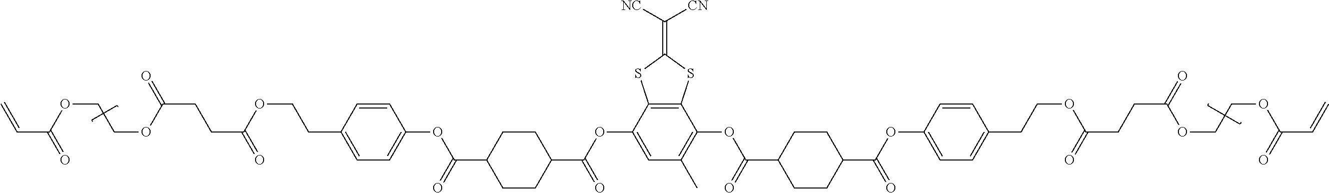 [SMILES: C=CC(=O)OCCOC(=O)CCC(=O)OCCc1ccc(OC(=O)C2CCC(C(=O)Oc3cc(C)c(OC(=O)C4CCC(C(=O)Oc5ccc(CCOC(=O)CCC(=O)OCCOC(=O)C=C)cc5)CC4)c4c3SC(=C(C#N)C#N)S4)CC2)cc1]

### Polymerizable Compound B2

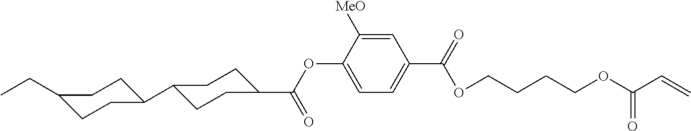 [SMILES: C=CC(=O)OCCCCOC(=O)c1ccc(OC(=O)C2CCC(C3CCC(CC)CC3)CC2)c(OC)c1]

### Polymerization Initiator P3

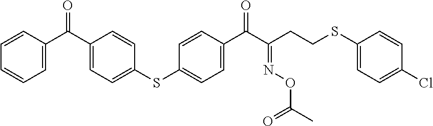 [SMILES: CC(=O)O/N=C(\CCSc1ccc(Cl)cc1)C(=O)c1ccc(Sc2ccc(C(=O)c3ccccc3)cc2)cc1]

### Surfactant S3

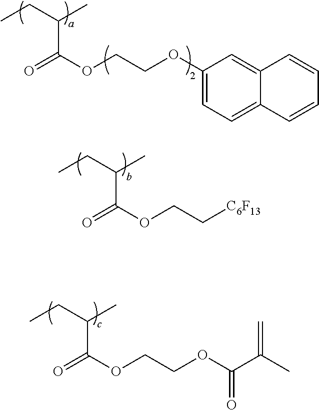

a=67.5, b=32.5, c=0

(Formation of Positive C-Plate Layer Including Vertically Aligned Rod-Like Liquid Crystal Compound having Reverse Wavelength Dispersibility)

A corona treatment was performed on the coating side surface of the positive A-plate prepared as described above at a discharge amount of 150 W·min/m², and a positive C-plate was prepared on the positive A-plate using the following composition 2 for forming a liquid crystal layer according to the same procedures as described above to obtain a positive C-plate. As a result, a laminate where the positive A-plate and the positive C-plate were laminated (laminate including the positive A-plate and the positive C-plate) was obtained.

The positive C-plate was a positive C-plate having reverse wavelength dispersibility, Re(550)=0.2 nm, Rth(550)=−420 nm, and Rth(450)/Rth(550)=0.95.

(Composition 2 for Forming Liquid Crystal Layer)

| | |
|---|---|
| • Liquid crystal compound R4 | 50.0 parts by mass |
| • Liquid crystal compound R2 | 33.3 parts by mass |
| • Liquid crystal compound R3 | 16.7 parts by mass |

| | |
|---|---|
| • Compound B1 | 1.5 parts by mass |
| • Monomer K1 | 4.0 parts by mass |

| | |
|---|---|
| • Polymerization initiator P1 | 5.0 parts by mass |
| • Polymerization initiator P2 | 2.0 parts by mass |

| | |
|---|---|
| • Surfactant S1 | 0.4 parts by mass |
| • Surfactant S2 | 0.5 parts by mass |
| • Acetone | 200.0 parts by mass |

| | |
|---|---|
| • Propylene Glycol Monomethyl Ether Acetate | 50.0 parts by mass |

### Liquid Crystal Compound R4

A mixture of the following liquid crystal compounds (RA), (RB), and (RC) at a ratio of 83:15:2 (mass ratio)

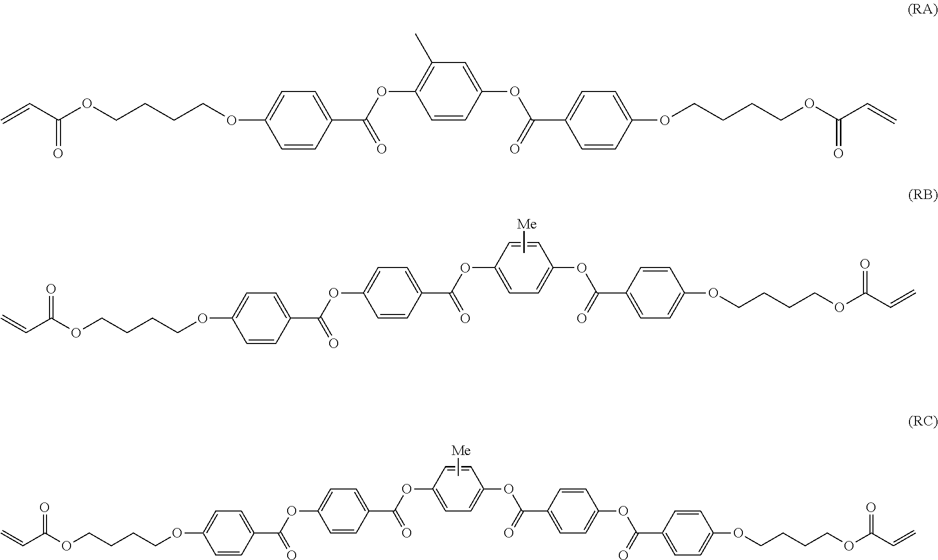

Compound B1

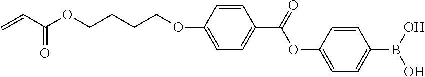 [SMILES: C=CC(=O)OCCCCOc1ccc(C(=O)Oc2ccc(B(O)O)cc2)cc1]

Monomer K1: A-TMMT (manufactured by Shin-Nakamura Chemical Co., Ltd.)

### Polymerization Initiator P1

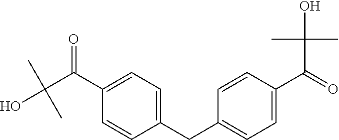 [SMILES: CC(C)(O)C(=O)c1ccc(Cc2ccc(C(=O)C(C)(C)O)cc2)cc1]

### Polymerization Initiator P2

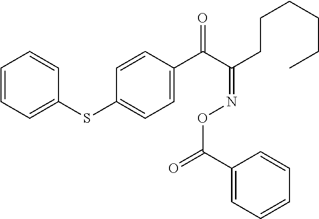 [SMILES: CCCCCC/C(=N/OC(=O)c1ccccc1)C(=O)c1ccc(Sc2ccccc2)cc1]

### Surfactant S1

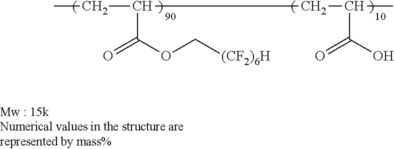

Surfactant S2 (weight-average molecular weight: 11,200)

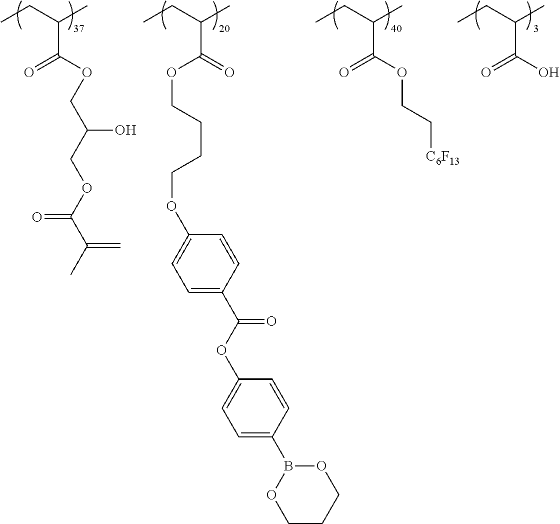

### Preparation of Laminate H including Anisotropic Light Absorbing Layer H

### [Formation of Photo-Alignment Film AL3]

A composition for forming a photo-alignment film described below was continuously applied to a cellulose acylate film Z-TAC (film thickness: 40 μm, manufactured by FUJIFILM Corporation) using a wire bar. The support on which the coating film was formed was dried with hot air at 140° C. for 120 seconds. Next, the coating film was irradiated with polarized ultraviolet light (10 mJ/cm², using an ultra-high pressure mercury lamp) to form a photo-alignment film AL3. As a result, a TAC film 3 with the photo-alignment film was obtained. The film thickness of the photo-alignment film AL3 was 1.0 μm.

Here, in a light guide plate of AR glasses described below, a slow axis of an anisotropic light absorbing layer H of a portion of an intermediate diffraction element was controlled to 0° with respect to the horizontal direction in a plane, and a slow axis of the anisotropic light absorbing layer H of a portion of an emission diffraction element was controlled to 90° with respect to the horizontal direction in a plane. In a case where the portion of the intermediate diffraction element was irradiated with polarized ultraviolet light, the portion of the emission diffraction element was masked to be prevented from being irradiated with polarized ultraviolet light. In a case where the portion of the emission diffraction element was irradiated with polarized ultraviolet light, the portion of the intermediate diffraction element was masked to be prevented from being irradiated with polarized ultraviolet light.

Composition for forming photo-alignment film

| | |
|---|---|
| • Polymer PA-1 shown below | 100.00 parts by mass |
| • Acid generator PAG-1 described above | 8.25 parts by mass |
| • Stabilizer DIPEA shown below | 0.6 parts by mass |

| | |
|---|---|
| • Xylene | 1126.60 parts by mass |
| • Methyl isobutyl ketone | 125.18 parts by mass |

Polymer PA-1 (in the formula, the numerical value described in each of repeating unit represents the content (mass %) of each of the repeating units with respect to all the repeating units)

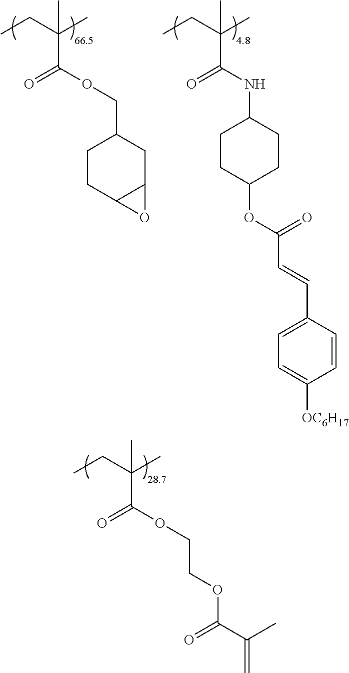

### Stabilizer DIPEA

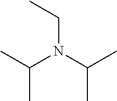

### [Preparation of Anisotropic Light Absorbing Layer H)

A composition for forming a light absorption anisotropic film having the following composition was continuously applied to the obtained photo-alignment film AL3 using a wire bar to form a coating film.

Next, the coating film was heated at 140° C. for 15 seconds, was heated at 80° C. for 5 seconds, and was cooled to room temperature (23° C.). Next, the coating film was heated at 75° C. for 60 seconds, and was cooled to room temperature again.

Next, the coating layer was irradiated with light using a LED lamp (central wavelength: 365 nm) for 2 seconds under an irradiation condition of an illuminance of 200 mW/cm² to prepare the anisotropic light absorbing layer H (polarizer) (thickness: 1.8 μm) on the photo-alignment film AL3.

Using an automatic polarizing film measuring device (trade name, VAP-7070, manufactured by Jasco Corporation), a single plate transmittance and a polarization degree of the anisotropic light absorbing layer H in a wavelength range of 280 to 780 nm were measured. An average transmittance of visible light corrected by luminosity was 42%. In addition, an average polarization degree of visible light corrected by luminosity was 99.68%.

Composition of Composition for Forming Light Absorption Anisotropic Film

| • First dichroic colorant Dye-C1 shown below | 0.65 parts by mass |
|---|---|
| • Second dichroic colorant Dye-M1 shown below | 0.15 parts by mass |
| • Third dichroic colorant Dye-Y1 shown below | 0.52 parts by mass |
| • Liquid crystal compound L-1 shown below | 2.69 parts by mass |
| • Liquid crystal compound L-2 shown below | 1.15 parts by mass |
| • Adhesion improver A-1 shown below | 0.17 parts by mass |
| • Polymerization initiator | |
| IRGACURE OXE-02 (manufactured by BASF SE) | 0.17 parts by mass |

| | |
|---|---|
| • Surfactant F-1 shown below | 0.013 parts by mass |
| • Cyclopentanone | 92.14 parts by mass |
| • Benzyl alcohol | 2.36 parts by mass |

### Dichroic Colorant Dye-C1

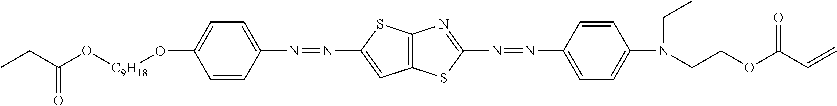

### Dichroic Colorant Dye-M1

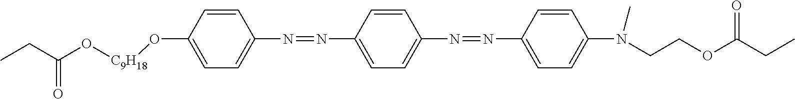

### Dichroic Colorant Dye-Y1

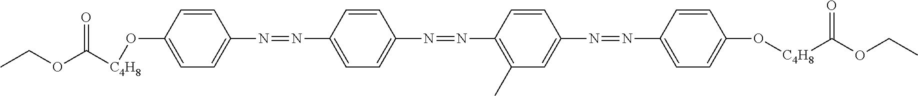

Liquid crystal compound L-1 (in the formulae, the numerical value (“59”, “15”, or “26”) described in each repeating unit denotes the content (mass %) of each of the repeating units with respect to all repeating units)

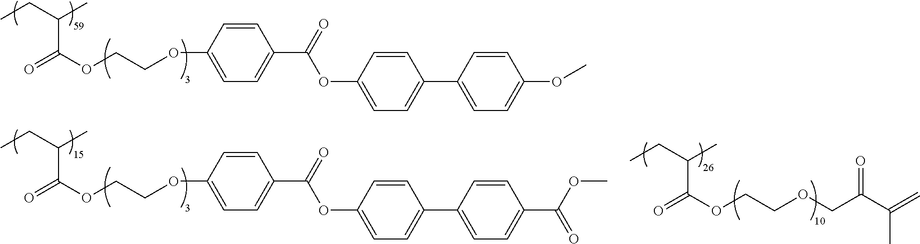

Liquid crystal compound L-2 [mixture of the following liquid crystal compounds (RA), (RB), and (RC) at a ratio of 84:14:2 (mass ratio)]

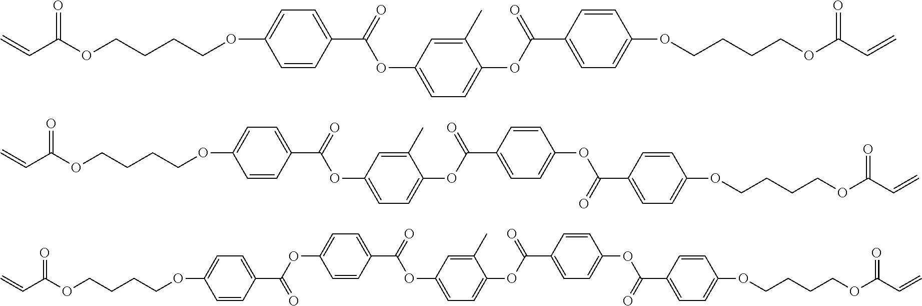

### Adhesion Improver A-1

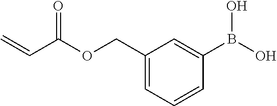

Surfactant F-1 (in the formulae, the numerical value described in each repeating unit denotes the content (mass %) of each of the repeating units with respect to all repeating units; Ac represents —C(O)CH3)

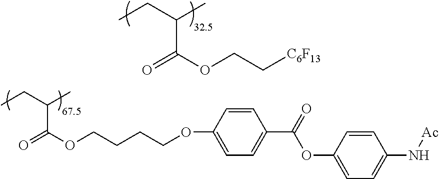

### [Formation of Oxygen Blocking Layer D1]

A coating liquid D1 having the following composition was continuously applied to the anisotropic light absorbing layer H using a wire bar. Next, by drying the coating film with hot air at 80° C. for 5 minutes, a laminate on which an oxygen blocking layer D1 consisting of polyvinyl alcohol (PVA) and having a thickness of 1.0 μm was formed, that is, a laminate H in which the cellulose acylate film Z-TAC (transparent support), the photo-alignment film AL3, the anisotropic light absorbing layer^{H}, and the oxygen blocking layer D1 were provided adjacent to each other in this order was obtained.

Composition of coating liquid D1
for forming oxygen blocking layer

| | |
|---|---|
| • Modified polyvinyl alcohol shown below | 3.80 parts by mass |

| | |
|---|---|
| • Initiator Irg2959 | 0.20 parts by mass |

| | |
|---|---|
| • Water | 70 parts by mass |
| • Methanol | 30 parts by mass |

### Modified Polyvinyl Alcohol

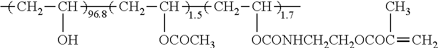

### Preparation of Retardation Layer Having Twisted Structure

### (Preparation of Photo-Alignment Film)

A coating liquid 1 for forming a photo-alignment film was prepared with reference to the description of Example 3 in JP2012-155308A.

The coating liquid 1 for forming a photo-alignment film prepared in advance was applied to one surface of a cellulose acetate film “Z-TAC) (manufactured by FUJIFILM Corporation; film thickness: 40 μm) using a bar coater. After the application, the coating film was dried on a hot plate at 120° C. for 2 minutes to remove the solvent, thereby forming a coating film. The obtained coating film was irradiated with polarized ultraviolet light (10 mJ/cm², using an ultra-high pressure mercury lamp) to prepare a TAC film 4 where the photo-alignment film 1 was formed.

(Formation of Retardation Layer having Twisted Structure Including Rod-like Liquid Crystal Compound)

A composition 1 for forming a liquid crystal layer having the following composition was prepared.

The composition 1 for forming a liquid crystal layer was applied to the photo-alignment film AL4 using a bar coater to form a composition layer. The formed composition layer was heated to 110° C. on a hot plate, and was cooled to 60° C. to stabilize the alignment. Then, the temperature was kept at 60° C., and the alignment was immobilized by ultraviolet irradiation (500 mJ/cm², using an ultra-high pressure mercury lamp) in a nitrogen atmosphere (oxygen concentration: 100 ppm) to prepare a retardation layer having a thickness of 3.5 μm where a 90° twisted structure was provided by adjusting the amount of a chiral agent. In the obtained retardation layer having the twisted structure, Δnd was 450 nm (wavelength: 550 nm).

(Composition 1 for forming liquid crystal layer)

| | |
|---|---|
| • Liquid crystal compound R1 | 84.00 parts by mass |
| • Polymerizable compound B2 | 16.00 parts by mass |
| • Polymerization initiator P3 | 0.50 parts by mass |

| | |
|---|---|
| • Surfactant S3 | 0.15 parts by mass |

• Chiral agent: 0.1 parts by mass
• Hisolve MTEM (manufactured by TOHO Chemical Industry Co., Ltd.)
2.00 parts by mass

| | |
|---|---|
| • NK ESTER A-200 (manufactured by Shin Nakamura Chemical Co., Ltd.) | 1.00 |

part by mass
• Methyl ethyl ketone 424.8 parts by mass

### Liquid Crystal Compound R1

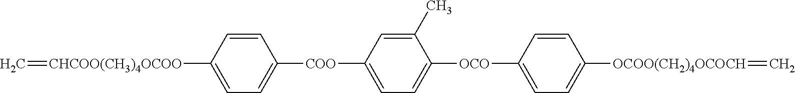

### Polymerizable Compound B2

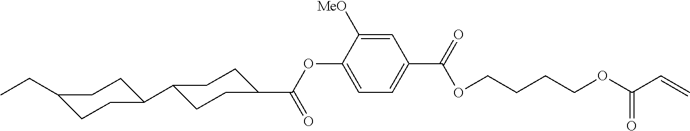 [SMILES: C=CC(=O)OCCCCOC(=O)c1ccc(OC(=O)C2CCC(C3CCC(CC)CC3)CC2)c(OC)c1]

### Polymerization Initiator P3

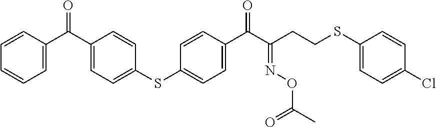 [SMILES: CC(=O)O/N=C(\CCSc1ccc(Cl)cc1)C(=O)c1ccc(Sc2ccc(C(=O)c3ccccc3)cc2)cc1]

### Surfactant S3

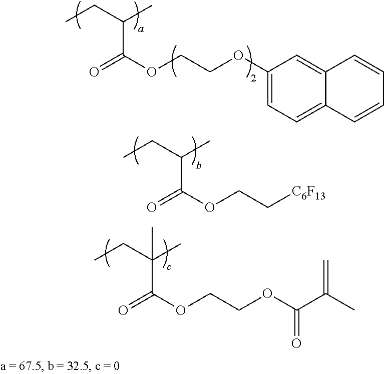

### Chiral Agent

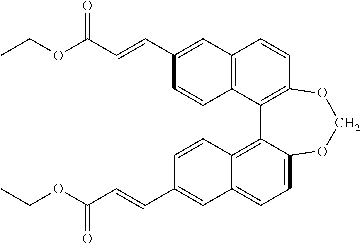

### Preparation of Pressure Sensitive Adhesives N1 and N2

Next, an acrylate-based polymer was prepared according to the following procedure.

95 parts by mass of butyl acrylate and 5 parts by mass of acrylic acid were polymerized by a solution polymerization method in a reaction container equipped with a cooling pipe, a nitrogen introduction pipe, a thermometer, and a stirrer, thereby obtaining an acrylate-based polymer (NA1) with an average molecular weight of 2000000 and a molecular weight distribution (Mw/Mn) of 3.0.

Next, an acrylate-based pressure sensitive adhesive was prepared with the following composition using the obtained acrylate-based polymer (NA1). The composition was applied a separate film having a surface treated with a silicone-based release agent using a die coater, was dried in an environment of 90° C. for 1 minute, and was irradiated with ultraviolet light (UV) under the following conditions, thereby obtaining the following acrylate-based pressure sensitive adhesives N1 and N2 (pressure-sensitive adhesive layers). The composition and the film thickness of the acrylate-based pressure sensitive adhesive are shown below.

### <UV Irradiation Conditions>

Electrodeless lamp H bulb (Fusion Co., Ltd.)
Illuminance: 600 mW/cm², light intensity: 150 mJ/cm²
The UV illuminance and the light intensity were measured using “UVPF-36” (manufactured by Eye Graphics Co., Ltd.).

Acrylate-based pressure sensitive adhesive N1 (film
thickness: 5 μm, storage elastic modulus: 2.6 MPa)

| | |
|---|---|
| • Acrylate-based polymer (NA1) | 100 parts by mass |

| | |
|---|---|
| • (A) Polyfunctional acrylate-based monomer shown below | 11.1 parts by mass |
| • (B) Photopolymerization initiator shown below | 1.1 parts by mass |
| • (C) Isocyanate-based crosslinking agent shown below | 1.0 part by mass |

| | |
|---|---|
| • (D) Silane coupling agent shown below | 0.2 parts by mass |

Acrylate-based pressure sensitive adhesive N2 (film
thickness: 15 μm, storage elastic modulus: 0.4 MPa)

| | |
|---|---|
| • Acrylate-based polymer (NA1) | 100 parts by mass |

| | |
|---|---|
| • (C) Isocyanate-based crosslinking agent shown below | 1.0 part by mass |

| | |
|---|---|
| • (D) Silane coupling agent shown below | 0.2 parts by mass |

(A) Polyfunctional acrylate-based monomer: tris (acryloyloxyethyl) isocyanurate, molecular weight=423, trifunctional type (manufactured by Toagosei Co., Ltd., trade name “ARONIX M-315”)

(B) Photopolymerization initiator: mixture of benzophenone and 1-hydroxycyclohexyl phenyl ketone at a mass ratio of 1:1, “IRGACURE 500” manufactured by Ciba Specialty Chemicals Corp.

(C) Isocyanate-based crosslinking agent: trimethylolpropane-modified tolylene diisocyanate (“CORONATE L” manufactured by Nippon Polyurethane Industry Co., Ltd.)

(D) Silane coupling agent: 3-glycidoxypropyltrimethoxysilane (“KBM-403” manufactured by Shin-Etsu Chemical Co., Ltd.)

### (Preparation of Optical Filter 1)

The PVA polarizer and the TAC film 1 surface of the laminate V were bonded to each other using the pressure-sensitive adhesive layer N1. Further, the pressure-sensitive adhesive layer N2 was bonded to the protective layer B1 surface of the laminate V to obtain an optical filter 1.

### (Preparation of Optical Filter 2)

The PVA polarizer and the B-plate were bonded to each other using the pressure-sensitive adhesive layer N1 such that the absorption axis of the PVA polarizer and the slow axis of the B-plate were parallel to each other. The surface of the B-plate opposite to the PVA polarizer and the TAC film 1 surface of the laminate V were bonded to each other using the pressure-sensitive adhesive layer N1. Further, the pressure-sensitive adhesive layer N2 was bonded to the protective layer B1 surface of the laminate V to obtain an optical filter 2.

### (Preparation of Optical Filter 3)

The PVA polarizer and the positive C-plate-side surface of the laminate including the positive A-plate and the positive C-plate were bonded to each other using the pressure-sensitive adhesive layer N1 such that the absorption axis of the PVA polarizer and the slow axis of the B-plate were parallel to each other. Next, the positive A-plate and the surface of the TAC film 1 of the laminate V were bonded to each other using the pressure-sensitive adhesive layer N1. Further, the pressure-sensitive adhesive layer N2 was bonded to the protective layer B1 surface of the laminate V to obtain an optical filter 3.

### (Preparation of Optical Filter 4)

The oxygen blocking layer D1 surface of the laminate H and the surface of the TAC film 1 of the laminate V were bonded to each other using the pressure-sensitive adhesive layer N1. Further, the pressure-sensitive adhesive layer N2 was bonded to the protective layer B1 surface of the laminate V to obtain an optical filter 4.

In this example, the laminate H acted as the polarizer.

### (Preparation of Optical Filter 5)

The protective layer B1 surface of the laminate V and the TAC film 2 surface of the retardation layer having the twisted structure were bonded to each other using the pressure-sensitive adhesive layer N1. The surface of the retardation layer having the twisted structure and the TAC film 1 surface of the second laminate V were bonded to each other using the pressure-sensitive adhesive layer N1. Further, the pressure-sensitive adhesive layer N2 was bonded to the protective layer B1 surface of the second laminate V to obtain an optical filter 5.

### (Preparation of Optical Filter 6)

The PVA polarizer and the TAC film 2 surface of the laminate V2 were bonded to each other using the pressure-sensitive adhesive layer N1. Further, the pressure-sensitive adhesive layer N2 was bonded to the protective layer B2 surface of the laminate V2 to obtain an optical filter 6.

### (Preparation of Optical Filter 7)

The PVA polarizer and the TAC film 1 surface of the laminate V3 were bonded to each other using the pressure-sensitive adhesive layer N1. Further, the pressure-sensitive adhesive layer N2 was bonded to the protective layer B1 surface of the laminate V3 to obtain an optical filter 7.

### (Preparation of Optical Filter 8)

The PVA polarizer and the TAC film 1 surface of the laminate V4 were bonded to each other using the pressure-sensitive adhesive layer N1. Further, the pressure-sensitive adhesive layer N2 was bonded to the protective layer B1 surface of the laminate V4 to obtain an optical filter 8.

### (Preparation of Optical Filter 9)

The PVA polarizer and the TAC film 1 surface of the laminate V5 were bonded to each other using the pressure-sensitive adhesive layer N1. Further, the pressure-sensitive adhesive layer N2 was bonded to the protective layer B1 surface of the laminate V5 to obtain an optical filter 9.

### (Preparation of Head-Mounted Display 1)

Alight shielding lens on the opposite observation surface of the right side of AR glasses (manufactured by Vuzix Japan Corporation, BLADE) was removed to prepare bonding of the optical filter to the light guide plate. The pressure-sensitive adhesive layer N2 of the optical filter 1 was bonded to the opposite observation surface side of the light guide plate to cover the entire light guide plate. As a result, a head-mounted display 1 was prepared.

In the AR glasses, the incidence diffraction element, the emission diffraction element, and the intermediate diffraction element were provided on the surface of the light guide plate as in FIG. 3.

In addition, as described above, the observation surface was the surface of the user side who used the AR glasses, and the opposite observation surface side was the surface opposite to the user who used the AR glasses, that is, the surface into which external light was incident.

### (Preparation of Head-Mounted Displays 2 to 5)

Instead of the optical filter 1 of the head-mounted display 1, each of the optical filters 2 to 5 was disposed as shown in Table 1 such that the pressure-sensitive adhesive layer N2 of the optical filter was bonded to the opposite observation surface side of the light guide plate to cover the entire light guide plate. As a result, head-mounted displays 2 to 5 were prepared.

### (Preparation of Head-Mounted Displays 6 to 8)

In each of the head-mounted displays 1, 2, and 5, the optical filter was also provided on the observation surface side of the light guide plate as in the opposite observation surface side. As a result, a head-mounted display 6 (optical filter 1), a head-mounted display 7 (optical filter 2), and a head-mounted display 8 (optical filter 5) were prepared.

### (Preparation of Head-Mounted Display 9)

A head-mounted display 9 was prepared by removing a light shielding lens on the opposite observation surface of the right side of AR glasses (manufactured by Vuzix Japan Corporation, BLADE).

### (Preparation of Head-Mounted Display 10)

Instead of the optical filter 1 of the head-mounted display 1, an HOYA absorptive ND filter OD1.5 50×50 (transmittance: 3%, manufactured by HOYA Corporation) was bonded to the opposite observation side of the light guide plate using the pressure-sensitive adhesive layer N2 to prepare a head-mounted display 10.

### (Preparation of Head-Mounted Display 11)

A head-mounted display 11 was prepared using the same method as that of the head-mounted display 1, except that the direction of the absorption axis of the polarizer of the optical filter 1 was changed from 0° with respect to the horizontal direction to 60° with respect to the horizontal direction.

### (Preparation of Head-Mounted Displays 12 to 15)

Instead of the optical filter 1 of the head-mounted display 1, each of the optical filters 6 to 9 was disposed as shown in Table 1 such that the pressure-sensitive adhesive layer N2 of the optical filter was bonded to the opposite observation surface side of the light guide plate to cover the entire light guide plate. As a result, head-mounted displays 12 to 15 were prepared.

### Evaluation

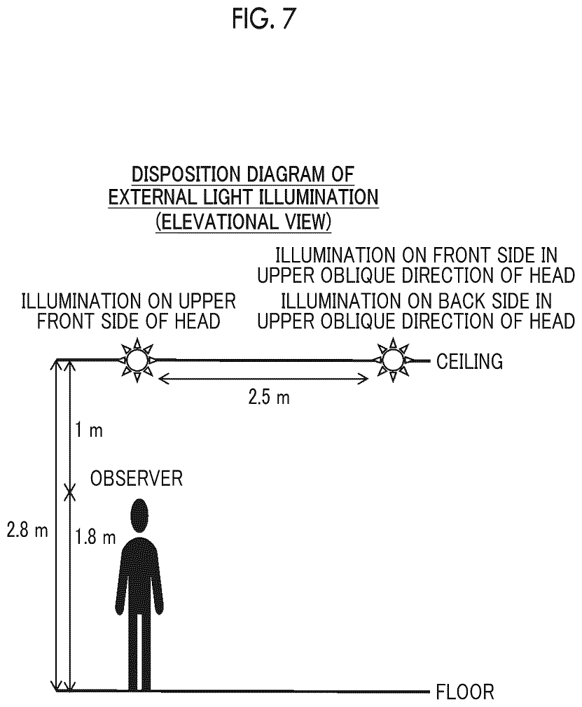

An observer having a height of 180 cm wore the prepared head-mounted display, and rainbow unevenness caused by external light from fluorescent lamps at three positions over the head were evaluated. In the evaluation system of the head-mounted display according to the embodiment of the present invention, the positions of the fluorescent lamps are shown in FIGS. 6 and 7, and the results are shown in Table 1.

Table 1 shows the visibility through the AR glasses, that is, the visibility of the background.
0: rainbow unevenness was clearly visible
1: rainbow unevenness was visible
2: rainbow unevenness was weakly visible
3: rainbow unevenness was slightly visible
4: rainbow unevenness was very slightly visible
5: rainbow unevenness was totally invisible

| | | | | | Slit Direction of | | |
|---|---|---|---|---|---|---|---|
| | | Opposite Observation | | | Diffraction Element | | |
| | | Surface Side | | | with respect to | | |
| | | | | Direction of | Horizontal Direction | | Observation |
| | Head- | | | Absorption Axis of | Intermediate | Emission | Surface Side |
| | Mounted | Optical | Optical Filter | Polarizer with respect | Diffraction | Diffraction | Optical |
| | Display | Filter | Configuration | to Horizonal Direction | Element | Element | Element |
| Example 1 | 1 | 1 | PVA Polarizer/ | 0° | 10° | 76° | None |
| | | | Laminate V | | | | |
| Example 2 | 2 | 2 | PVA Polarizer/ | 0° | 10° | 76° | None |
| | | | B-Plate/ | | | | |
| | | | Laminate V | | | | |
| Example 3 | 3 | 3 | PVA Polarizer/ | 0° | 10° | 76° | None |
| | | | Laminate Including | | | | |
| | | | Positive A-Plate | | | | |
| | | | and Positive C-Plate/ | | | | |
| | | | Laminate V | | | | |
| Example 4 | 4 | 4 | Laminate H/ | 0° (Intermediate | 10° | 76° | None |
| | | | Laminate V | Diffraction | | | |
| | | | | Element Portion) | | | |
| | | | | 90° (Emission | | | |
| | | | | Diffraction | | | |
| | | | | Element Portion) | | | |
| Example 5 | 5 | 5 | Laminate V/ | — | 10° | 76° | None |
| | | | Retardation | | | | |
| | | | Layer having | | | | |
| | | | Twisted Structure/ | | | | |
| | | | Laminate V | | | | |
| Example 6 | 6 | 1 | PVA Polarizer/ | 0° | 10° | 76° | 1 |
| | | | Laminate V | | | | |
| Example 7 | 7 | 2 | PVA Polarizer/ | 0° | 10° | 76° | 2 |
| | | | B-Plate/ | | | | |
| | | | Laminate V | | | | |
| Example 8 | 8 | 5 | Laminate V/ | — | 10° | 76° | 5 |
| | | | Retardation | | | | |
| | | | Layer having | | | | |
| | | | Twisted Structure/ | | | | |
| | | | Laminate V | | | | |
| Comparative | 9 | None | None | — | 10° | 76° | None |
| Example 1 | | | | | | | |
| Comparative | 10 | ND Filter | Hoya Absorptive | — | 10° | 76° | None |
| Example 2 | | (Transmit- | ND Filter | | | | |
| | | tance: 3%) | OD 1.5 50 × 50 | | | | |
| Example 9 | 11 | 1 | PVA Polarizer/ | 60° | 10° | 76° | None |
| | | | Laminate V | | | | |
| Example 10 | 12 | 6 | PVA Polarizer/ | 0° | 10° | 76° | None |
| | | | Laminate V2 | | | | |
| Example 11 | 13 | 7 | PVA Polarizer/ | 0° | 10° | 76° | None |
| | | | Laminate V3 | | | | |
| Example 12 | 14 | 8 | PVAPolarizer/ | 0° | 10° | 76° | None |
| | | | Laminate V4 | | | | |
| Example 13 | 15 | 9 | PVA Polarizer/ | 0° | 10° | 76° | None |
| | | | LaminateV5 | | | | |

| | Observation | | | | | |
|---|---|---|---|---|---|---|
| | Surface Side | | | | | |
| | Direction of | Rainbow Unevenness Results | | | | |
| | Absorption Axis of | | Front Side in | Back Side in | Front | Visibility |
| | Polarizer with respect | Upper Front | Upper Oblique | Upper Oblique | Transmit- | through AR |
| | to Horizonal Direction | Side of Head | Direction of Head | Direction of Head | tance | Glasses |
| Example 1 | — | 5 | 3 | 0 | 33% | Sufficient |
| | | | | | | Visibility |
| Example 2 | — | 5 | 4 | 0 | 33% | Sufficient |
| | | | | | | Visibility |
| Example 3 | — | 5 | 4 | 0 | 33% | Sufficient |
| | | | | | | Visibility |
| Example 4 | — | 5 | 5 | 0 | 33% | Sufficient |
| | | | | | | Visibility |
| Example 5 | — | 5 | 5 | 0 | 63% | Excellent |
| | | | | | | Visibility |
| Example 6 | 0° | 5 | 3 | 3 | 28% | Sufficient |
| | | | | | | Visibility |
| Example 7 | 0° | 5 | 4 | 4 | 28% | Sufficient |
| | | | | | | Visibility |
| Example 8 | — | 5 | 5 | 5 | 61% | Excellent |
| | | | | | | Visibility |
| Comparative | — | 0 | 0 | 0 | 96% | Excellent |
| Example 1 | | | | | | Visibility |
| Comparative | — | 5 | 5 | 0 | 3% | Dark and |
| Example 2 | | | | | | Insufficient |
| | | | | | | Visibility |
| Example 9 | — | 3 | 5 | 0 | 33% | Sufficient |
| | | | | | | Visibility |
| Example 10 | — | 5 | 3 | 0 | 33% | Sufficient |
| | | | | | | Visibility |
| Example 11 | — | 5 | 3 | 0 | 25% | Sufficient |
| | | | | | | Visibility |
| Example 12 | — | 5 | 3 | 0 | 26% | Sufficient |
| | | | | | | Visibility |
| Example 13 | — | 5 | 3 | 0 | 22% | Sufficient |
| | | | | | | Visibility |

As shown in Table 1, in the head-mounted display according to the embodiment of the present invention, the visibility of the background is sufficient, and rainbow unevenness caused by external light incident from the upper front side of the head is suitably suppressed. In addition, as shown in Examples 1, 9, and 10 to 13, with the configuration where the angle between the slit direction of the diffraction element and the absorption axis of the polarizer was 0° to 45°, the visibility of rainbow unevenness can be more suitably suppressed.

In addition, as shown in Examples 2, 3, and 5, with the configuration where the optical filter includes the retardation layer, rainbow unevenness caused by external light incident from the front side in the upper oblique direction of the head can also be suitably suppressed. Further, as shown in Example 4, in the emission diffraction element where the angle of the slit direction of the diffraction element with respect to the horizontal direction is 76°, with the configuration where the angle between the slit direction of the diffraction element and the absorption axis of the polarizer was 0° to 45°, rainbow unevenness caused by external light incident from the front side in the upper oblique direction of the head can also be suitably suppressed.

Further, as shown in Examples 6 to 8, by disposing the optical filter on both surfaces of the light guide plate, rainbow unevenness caused by external light incident from the back side in the upper oblique direction of the head can also be suitably suppressed.

On the other hand, in the head-mounted display according to Comparative Example 1 not including the optical filter, the visibility of the background was high, but rainbow unevenness was not able to be suppressed.

On the other hand, in the head-mounted display according to Comparative Example 2 where the ND filter was used instead of the optical filter, rainbow unevenness was able to be suppressed, but the visibility of the background was poor.

As can be seen from the above results, the effects of the present invention are obvious.

### EXPLANATION OF REFERENCES

10, 10m: optical filter
12: polarizer
14: anisotropic light absorbing layer
80: head-mounted display
82: light guide plate
90: incidence diffraction element
92: emission diffraction element
94: intermediate diffraction element
180: head-mounted display
I₀: front external light
I₁: video light
I_{S}: oblique external light

What is claimed is:

1. An optical device comprising:
a light guide plate having a surface on which a diffraction element is disposed; and
an optical filter that includes an anisotropic light absorbing layer,
wherein an angle between an absorption axis of the anisotropic light absorbing layer and a normal direction of a main surface of the anisotropic light absorbing layer is 0° to 45°.

2. The optical device according to claim 1,
wherein the optical filter further includes a polarizer having an absorption axis in a main surface.

3. The optical device according to claim 2,
wherein an angle between a slit direction of a diffraction element where the slit direction is closest to a horizontal direction among the diffraction elements and an absorption axis of the polarizer is 0° to 45°.

4. The optical device according to claim 1,
wherein two or more diffraction elements are disposed on the light guide plate, and
the optical filter is provided to cover at least a diffraction element where an angle between a slit direction and a horizontal direction is smallest among the diffraction elements.

5. The optical device according to claim 2,
wherein the optical filter includes a retardation layer between the anisotropic light absorbing layer and the polarizer.

6. The optical device according to claim 5,
wherein the retardation layer is a B-plate having an Nz coefficient of 1.5 or more.

7. The optical device according to claim 5,
wherein the retardation layer includes at least a positive A-plate and a positive C-plate, and
the positive A-plate is provided on an anisotropic light absorbing layer side.

8. The optical device according to claim 2,
wherein on a surface of the light guide plate, an incidence diffraction element for allowing light to be incident into the light guide plate, an intermediate diffraction element that deflects a light guide direction of light diffracted by the incidence diffraction element, and an emission diffraction element that emits light diffracted by the intermediate diffraction element from the light guide plate are disposed.

9. The optical device according to claim 8,
wherein a slit direction of the intermediate diffraction element and a slit direction of the emission diffraction element are different from each other,
the optical filter is provided in a region covering the intermediate diffraction element and in a region covering the emission diffraction element,
a direction of an absorption axis of the polarizer of the optical filter varies between the region covering the intermediate diffraction element and the region covering the emission diffraction element,
an angle between the absorption axis of the polarizer of the optical filter and the slit direction of the intermediate diffraction element is 0° to 45°, and
an angle between the absorption axis of the polarizer of the optical filter and the slit direction of the emission diffraction element is 0° to 45°.

10. The optical device according to claim 1,
wherein the optical filter includes at least a first anisotropic light absorbing layer, one or more retardation layers having a twisted structure, and a second anisotropic light absorbing layer.

11. The optical device according to claim 1,
wherein the optical filter is disposed on an opposite observation surface side of the light guide plate.

12. The optical device according to claim 1,
wherein the optical filter is disposed on both surfaces of the light guide plate.

13. The optical device according to claim 5,
wherein wavelength dependence of the retardation layer of the optical filter satisfies Re(450 nm)<Re(550 nm)<Re(650 nm) or Rth(450 nm)<Rth(550 nm)<Rth(650 nm).

14. A head-mounted display comprising:
the optical device according to claim 1; and
an image display element.

15. The optical device according to claim 2,
wherein two or more diffraction elements are disposed on the light guide plate, and
the optical filter is provided to cover at least a diffraction element where an angle between a slit direction and a horizontal direction is smallest among the diffraction elements.

16. The optical device according to claim 3,
wherein the optical filter includes a retardation layer between the anisotropic light absorbing layer and the polarizer.

17. The optical device according to claim 16,
wherein the retardation layer is a B-plate having an Nz coefficient of 1.5 or more.

18. The optical device according to claim 16,
wherein the retardation layer includes at least a positive A-plate and a positive C-plate, and
the positive A-plate is provided on an anisotropic light absorbing layer side.

19. The optical device according to claim 3,
wherein on a surface of the light guide plate, an incidence diffraction element for allowing light to be incident into the light guide plate, an intermediate diffraction element that deflects a light guide direction of light diffracted by the incidence diffraction element, and an emission diffraction element that emits light diffracted by the intermediate diffraction element from the light guide plate are disposed.

20. The optical device according to claim 19,
wherein a slit direction of the intermediate diffraction element and a slit direction of the emission diffraction element are different from each other,
the optical filter is provided in a region covering the intermediate diffraction element and in a region covering the emission diffraction element,
a direction of an absorption axis of the polarizer of the optical filter varies between the region covering the intermediate diffraction element and the region covering the emission diffraction element,
an angle between the absorption axis of the polarizer of the optical filter and the slit direction of the intermediate diffraction element is 0° to 45°, and
an angle between the absorption axis of the polarizer of the optical filter and the slit direction of the emission diffraction element is 0° to 45°.
